(19) United States
(12) Patent Application Publication
(10) Pub. No.: US 2023/0107979 A1
(43) Pub. Date: Apr. 6, 2023

(54) ELECTRODE FOR LITHIUM-ION BATTERY AND LITHIUM-ION BATTERY

(71) Applicant: APB CORPORATION, Tokyo (JP)

(72) Inventors: Hideki NISHIMURA, Kyoto (JP); Moe KITABA, Kyoto (JP); Yuki NEKOHASHI, Kyoto (JP); Yusuke MIZUNO, Kyoto (JP); Kazuya MINAMI, Kyoto (JP); Hideaki HORIE, Tokyo (JP)

(73) Assignee: APB CORPORATION, Tokyo (JP)

(21) Appl. No.: 17/796,048

(22) PCT Filed: Feb. 4, 2021
(86) PCT No.: PCT/JP2021/004070

§ 371 Date: Jul. 28, 2022

(30) Foreign Application Priority Data
Feb. 4, 2020 (JP) 2020-017029
Mar. 10, 2020 (JP) 2020-040906

(51) Int. Cl. H01M 4/66; H01M 4/62

(52) U.S. Cl. CPC H01M 4/66; H01M 4/628; H01M 4/626; H01M 2004/021

(57) ABSTRACT

An electrode for a lithium-ion battery, comprising a resin current collector; and an electrode active material layer formed on the resin current collector, and containing coated electrode active material particles in which at least a part of a surface of an electrode active material particle is coated with a coating layer including a polymer compound, wherein the resin current collector has a recess on a principal surface that comes into contact with the electrode active material layer, the relationship between the maximum depth (D) of the recess and the D50 particle size (R) of the electrode active material particles satisfies 1.0R≤D≤6.5R, and the relationship between the length (S) of the shortest part of the length passing through the center of gravity of the recess and the D50 particle size (R) of the electrode active material particles satisfies 1.5R≤S.

### TECHNICAL FIELD

The present invention relates to an electrode for a lithium-ion battery and a lithium-ion battery.

### BACKGROUND ART

A lithium-ion (secondary) battery is used for various applications as a high-capacity, small-sized, and lightweight secondary battery in recent years.

In the lithium ion battery, an electrode is generally formed by applying a positive electrode active material or a negative electrode active material or the like to a positive electrode current collector or a negative electrode current collector using a binder. In addition, in a case of a bipolar battery, a bipolar electrode, which has a positive electrode layer by applying a positive electrode active material or the like using a binder on one surface of a current collector, and has a negative electrode layer by applying a negative electrode active material or the like using a binder to the opposite surface, is configured.

Patent Literature 1 describes forming an concavoconvex shape on the surface where the resin current collector and the active material layer come into contact, thereby reducing contact resistance between the resin current collector and the active material layer.

Further, Patent Literature 1 describes, as a method to obtain the concavoconvex shape, a method comprising applying ink containing a conductive material to the resin current collector to form a coating film on the resin current collector; pressing a mold comprising a surface shape of the concavoconvex shape against the coating film of the resin current collector to perform hot pressing and thus to form the surface shape of the mold on the resin current collector.

### CITATION LIST

### Patent Literature

PTL 1: Japanese Unexamined Patent Application, First Publication No. 2017-84507

### SUMMARY OF THE INVENTION

### Technical Problem

In Patent Literature 1, a slurry that is a mixture of hard carbon and a resin is used as an ink containing a conductive material. However, since this ink has a large shrinkage when drying a solvent, the smoothness of the resin current collector itself is likely to be impaired. Further, there is a problem that the coating film is easily peeled off due to residual strain.

Peeling off of the coating film leads to an increase in the internal resistance of the battery, and also a decrease in cycle characteristics.

In view of the foregoing, the present invention has been made, and an object of thereof is to provide electrode for a lithium-ion battery which reduces contact resistance between the resin current collector and the electrode active material layer and has excellent adhesiveness between the resin current collector and the electrode active material layer.

### Solution to Problem

The present invention relates to an electrode for a lithium-ion battery, comprising a resin current collector; and an electrode active material layer formed on the resin current collector, and containing coated electrode active material particles in which at least a part of a surface of an electrode active material particle is coated with a coating layer including a polymer compound, wherein the resin current collector has a recess on a principal surface that comes into contact with the electrode active material layer, the relationship between the maximum depth (D) of the recess and the D50 particle size (R) of the electrode active material particles satisfies 1.0 R≤D≤6.5 R, and the relationship between the length (S) of the shortest part of the length passing through the center of gravity of the recess and the D50 particle size (R) of the electrode active material particles satisfies 1.5 R≤S; and also related to a lithium-ion battery, comprising the electrode for a lithium-ion battery.

### Advantageous Effects of Invention

According to the present invention, it is possible to provide an electrode for a lithium-ion battery which reduces contact resistance between a resin current collector and an electrode active material layer and has excellent adhesiveness between a resin current collector and an electrode active material layer.

### BRIEF DESCRIPTION OF DRAWINGS

FIG. 1 is a cross-sectional view schematically showing an example of a resin current collector.

FIG. 2 is a perspective view schematically showing an example of a resin current collector.

FIG. 3 is an enlarged top view of a part of the resin current collector shown in FIG. 2.

FIG. 4 is a cross-sectional view schematically showing an example of the electrode for a lithium-ion battery.

FIG. 5 is a perspective view schematically showing another example of a resin current collector.

FIG. 6 is a perspective view schematically showing an example of a resin current collector having a conductive filler layer.

FIG. 7 is a perspective view schematically showing a state in which a recess is formed by using a mesh.

### DESCRIPTION OF EMBODIMENTS

The present invention will be described in detail below.

An electrode for a lithium-ion battery of the present invention is an electrode for a lithium-ion battery having a resin current collector and an electrode active material layer formed on the resin current collector, and containing coated electrode active material particles in which at least a part of a surface of an electrode active material particle is coated with a coating layer including a polymer compound, wherein the resin current collector has a recess on a principal surface that comes into contact with the electrode active material layer, the relationship between the maximum depth (D) of the recess and the D50 particle size (R) of the electrode active material particles satisfies 1.0 R≤D≤6.5 R, and the relationship between the length (S) of the shortest part of the length passing through the center of gravity of the recess and the D50 particle size (R) of the electrode active material particles satisfies 1.5 R≤S.

The electrode for a lithium-ion battery of the present invention is composed of a resin current collector and an electrode active material layer.

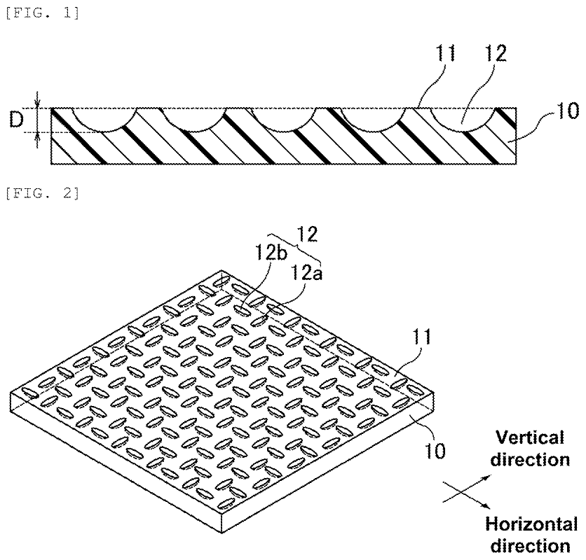

FIG. 1 is a cross-sectional view schematically showing an example of a resin current collector.

The resin current collector 10 is used in contact with the electrode active material layer. resin current collector 10 has recesses 12 on a principal surface 11 which comes into contact with the electrode active material layer.

The maximum depth of the recess is herein referred to as D. In FIG. 1, the maximum depth D of the recess 12 is shown by a double-headed arrow D.

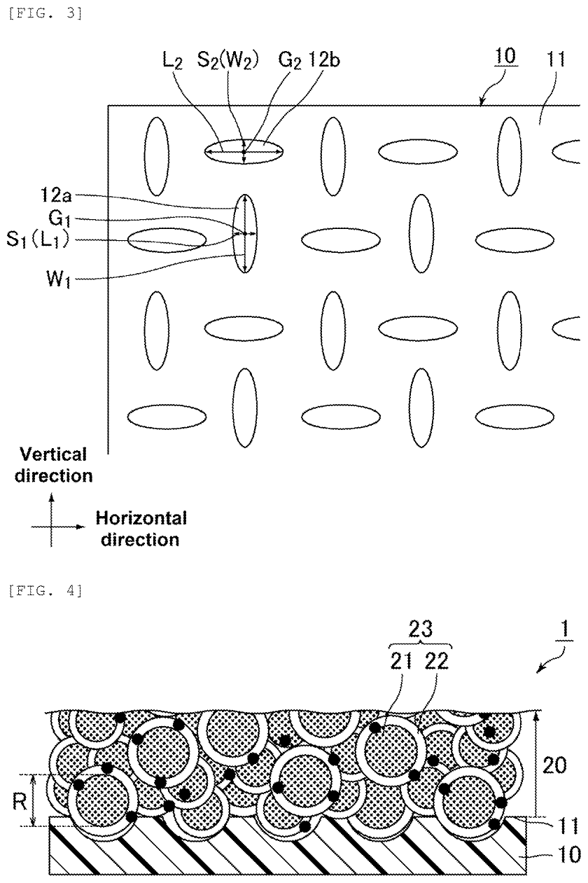

FIG. 2 is a perspective view schematically showing an example of a resin current collector, and FIG. 3 is an enlarged top view of a part of the resin current collector shown in FIG. 2.

The recesses 12 provided on the principal surface 11 of the resin current collector 10 has a recess 12a which is an elliptical shape long in a vertical direction and a recess 12b which is an elliptical shape long in a horizontal direction.

As shown in FIG. 3, the length of the shortest portion of lengths passing through a centroid of the recess as seen from above is referred to as S.

A centroid of the recess 12a is G1, and the length of the referred to as the length S is a length indicated by a double-headed arrow S1 (double-headed arrow L1).

A centroid of the recess 12b is G2, and the length of the referred to as the length S is a length indicated by a double-headed arrow S2 (double-headed arrow W2).

In a case where the recess is an elliptical shape, the length of the shortest portion lengths passing through the centroid is a length of a minor axis.

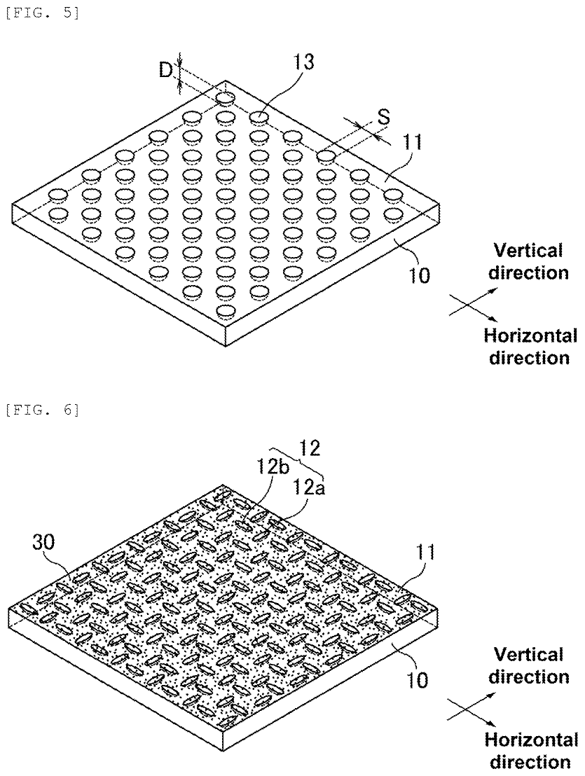

FIG. 4 is a cross-sectional view schematically showing an example of the electrode for a lithium-ion battery. An electrode for a lithium-ion battery 1 is provided with an electrode active material layer 20 provided on the principal surface 11 of the resin current collector 10.

The electrode active material layer 20 includes coated electrode active material particles 23. The coated electrode active material particles 23 are formed by coating at least a part of the surface of the electrode active material particles 21 with a coating layer including a polymer compound.

D50 particle size of the electrode active material particles is herein referred to as R. In FIG. 4, the particle size D of the electrode active material particles is shown by a double-headed arrow R.

The D50 particle size (R) of the electrode active material means the particle size (Dv50) at an integrated value of 50% in the particle size distribution obtained by the microtrack method (the laser diffraction/scattering method). The microtrack method is a method of determining a particle size distribution by using scattered light obtained by irradiating particles with laser light. A MICROTRAC manufactured by Nikkiso Co., Ltd. can be used for measuring the volume average particle size.

The D50 particle size (R) of the electrode active material is the particle size of the electrode active material particles which does not include the coating layer.

Further, the D50 particle size (R) of the electrode active material is preferably 5 to 25 μm.

The D50 particle size (R) of the electrode active material contained in the electrode for a lithium-ion battery can be measured after carrying out the ultrasonic cleaning with a solvent system used to form the coating layer of the coated electrode active material particles, and separating the electrode active material particles using a centrifuge separator.

The particle size of the coated electrode active material particles can also be measured by the microtrack method, and the D50 particle size (R) of the coated electrode active material is preferably 5 to 25 μm.

When the maximum depth D and the length S of the recess of the resin current collector and the particle size R of the electrode active material particles are determined as described above, the following relationships (i) and (ii) are established:

1.0 R≤D≤6.5 R (i)

1.5 R≤S (ii)

If the above relations (i) and (ii) are satisfied, the recess of the resin current collector is filled with the coated electrode active material particles, and the contact resistance between the resin current collector and the electrode active material layer becomes reduced. Further, the adhesiveness between the resin current collector and the electrode active material layer is excellent.

For the formula (i), if D is less than 1.0 R, the adhesiveness between the resin current collector and the electrode active material layer becomes insufficient, so that the electrode active material layer formed on the resin current collector may cause displacement during production of a battery.

Further, if D exceeds 6.5 R, the active material density in the recess becomes smaller than the active material density in the active material layer bulk. Since the electrode strength (adhesive strength) in the recess where the active material density is small becomes reduced, it becomes difficult to fix the resin current collector and the electrode active material layer, so that the displacement of the resin current collector and the electrode active material layer may occur.

If the resin current collector and the electrode active material layer are misaligned, the battery performance may deteriorate.

For the formula (ii), if S is less than 1.5 R, the recess is not sufficiently filled with the coated electrode active material particles, so that the contact resistance between the resin current collector and the electrode active material layer cannot be reduced.

Preferred embodiments of the resin current collector and the electrode active material layer that the electrode for a lithium-ion battery of the present invention is provided with will be described below.

First, the resin current collector will be described.

The shape of the recess as seen from above is not particularly limited, but examples of a preferred shape include an elliptical shape, a circular shape, a polygonal shape (rectangles, squares, parallelograms, rhombuses, other quadrilaterals, triangles, pentagons, hexagons, and the like), a donut shape with curved outer circumference, and a frame shape with straight outer circumference.

The length of the shortest portion of lengths passing through a centroid of the recess of the resin current collector is preferably 30 to 105 μm

In a case where the length of the shortest portion of lengths passing through the centroid of the recess is less than 30 μm, when a slurry including the coated electrode active material particles is disposed on the resin current collector and press-molded, the recesses are not sufficiently filled with the coated electrode active material particles, so that an effect of improving the surface area is not exhibited.

On the other hand, in a case where the length of the shortest portion of lengths passing through the centroid of the recess is more than 105 μm, a degree of surface area improvement by providing the recess on the principal surface of the resin current collector is not sufficient.

For the measurement of the length of the shortest portion of lengths passing through the centroid of the recess of the resin current collector, in a case where the recess is a donut shape or a frame shape, the length of the shortest portion of the length from the center line, which is determined by drawing a normal line with respect to the center line between the outer periphery and the inner periphery of recess, to the inner periphery or the outer periphery is determined.

A three-dimensional shape of the recess may be a shape in which the depth is constant, or may be a shape in which the depth is different in the recess. Examples of the shape in which the depth is different in the recess include a shape in which the three-dimensional shape is a semi-elliptical sphere in a case where the recess has an elliptical shape as seen from above.

The depth of the recess is preferably 10 to 45 μm. In a case where the depth of the recess is 10 μm or more, the effect of improving the surface area by providing the recess on the principal surface of the resin current collector is suitably exhibited. Further, in a case where the depth of the recess exceeds 45 μm, the resin current collector may be cracked.

The depth of the recess is defined as the maximum depth D that is the depth of the deepest part of the recess.

It is preferable that the recess of the resin current collector has two or more recesses having different shapes of figures as seen from above.

The two or more recesses having different shapes of figures as seen from above mean the following cases:

(1) in a case where types of geometric figures are different, for example, a case of being a rectangle shape and an ellipse shape;

(2) in a case where dimensions of the same geometry are different, for example, a case of two types of ellipses or a case of two types of ellipses (that is, similar figures) with the same flattening but different lengths on the major and minor axis; or

(3) in a case where orientation of the recesses is different, for example, a case where ellipses having the same shape have a major axis oriented in the vertical direction or have a major axis oriented in the horizontal direction.

The recess shown in FIGS. 2 and 3 corresponds to a case where, in the case of (3) described above, the geometric figure is the same ellipse and consists of the recess 12a in which a major axis direction is oriented in the vertical direction and the recess 12b in which a major axis direction is oriented in the horizontal direction.

Since the recesses have two or more recesses having different shapes of figures as seen from above, it is possible to prevent an electrode active material layer from being displaced from the resin current collector due to activity of the electrode active material layer (volume change and accumulation of side reactants) by the repeated charging and discharging.

It is preferable that the recess has a recess having an aspect ratio of 2.0 to 4.0 and a recess having an aspect ratio of 0.25 to 0.5.

The aspect ratio of the recess is a ratio represented by “Dimension of recess in vertical direction/Dimension of recess in horizontal direction”. In the recess shown in FIG. 3, the aspect ratio of the recess 12a is represented by W₁/L₁, and the aspect ratio of the recess 12b is represented by W_{2/}L₂. W₁ and W₂ are dimensions of each recess in the vertical direction, and L₁ and L₂ are dimensions of each recess in the horizontal direction.

In the dimensions shown in the drawings, the aspect ratio (W₁/L₁) of the recess 12a exceeds 1.0, and the aspect ratio (W₂/L₂) of the recess 12b is less than 1.0.

In a case of having such two types of recesses, it is preferable that the aspect ratio of the recess having a large aspect ratio is 2.0 to 4.0 and the aspect ratio of the recess having a small aspect ratio is 0.25 to 0.5.

By setting the combination of aspect ratios to such a range, it is possible to prevent the electrode active material layer from being displaced from the resin current collector due to activity of the electrode active material layer (volume change and accumulation of side reactants) by the repeated charging and discharging.

The shape of the recess of the resin current collector may be the same shape as seen from above. For example, only a recess having a circular shape as seen from above may be provided.

FIG. 5 is a perspective view schematically showing another example of a resin current collector.

A recess 13 provided on the principal surface 11 of the resin current collector 10 shown in FIG. 5 is a recess having a circular top view shape. A resin current collector having such a shape of recess can also be used as a resin current collector of the electrode for a lithium-ion battery of the present invention.

The length S of the shortest portion of the length passing through the centroid of the recess as seen from above is the diameter of the circle.

It is preferable that the resin current collector consists of a resin composition including a polymer material and a conductive filler.

Examples of the polymer material include polyethylene (PE), polypropylene (PP), polymethylpentene (PMP), polycycloolefin (PCO), polyethylene terephthalate (PET), polyether nitrile (PEN), polytetrafluoroethylene (PTFE), styrene butadiene rubber (SBR), polyacrylonitrile (PAN), polymethylacrylate (PMA), polymethylmethacrylate (PMMA), polyvinylidene fluoride (PVdF), an epoxy resin, a silicone resin, and a mixture thereof.

From the viewpoint of electrical stability, polyethylene (PE), polypropylene (PP), polymethylpentene (PMP), or polycycloolefin (PCO) is preferable, and polyethylene (PE), polypropylene (PP), or polymethylpentene (PMP) is more preferable.

Examples of the conductive filler include, but are not limited thereto, a metal [nickel, aluminum, stainless steel (SUS), silver, copper, titanium, or the like], carbon [graphite or carbon black (acetylene black, Ketjen black, furnace black, channel black, thermal lamp black, or the like), or the like], and a mixture thereof.

One kind of these materials may be used alone, or two or more kinds thereof may be used in combination. Moreover, an alloy or metal oxide thereof may be used. From the viewpoint of electrical stability, aluminum, stainless steel, carbon, silver, copper, titanium, a mixtures thereof is preferable, silver, aluminum, stainless steel, or carbon is more preferable, and carbon is still more preferable. Further, these conductive fillers may be those obtained by coating a conductive material (a metallic conductive filler among the above-described materials) around a particle-based ceramic material or a resin material with plating or the like.

An average particle size of the conductive filler is not particularly limited; however, it is preferably 0.01 to 10 μm, more preferably 0.02 to 5 μm, and still more preferably 0.03 to 1 μm, from the viewpoint of the electrical characteristics of the battery. In the present specification, the “average particle size of the conductive filler” means the maximum distance L among distances between any two points on the contour line of the conductive filler. As the value of the “average particle size”, the average value of the particle sizes of the particles observed in several to several tens of visual fields using an observation means such as a scanning electron microscope (SEM) or a transmission electron microscope (TEM) shall be calculated and adopted.

A shape (form) of the conductive filler is not limited to the particle form, may be a form other than the particle form, and may be a form practically applied as a so-called filler-based conductive material such as carbon nanotubes.

The conductive filler may be a conductive fiber of which the shape is fibrous.

Examples of the conductive fiber include a carbon fiber such as a PAN-based carbon fiber or a pitch-based carbon fiber, a conductive fiber obtained by uniformly dispersing a metal having good conductivity or graphite in the synthetic fiber, a metal fiber obtained by making a metal such as stainless steel into a fiber, a conductive fiber obtained by coating a surface of an organic fiber coated with a metal, and a conductive fiber obtained by coating a surface of an organic fiber with a resin including a conductive substance. Among these conductive fibers, a carbon fiber is preferable. In addition, a polypropylene resin in which graphene is kneaded is also preferable.

In a case where the conductive filler is a conductive fiber, the average fiber diameter thereof is preferably 0.1 to 20 μm.

A weight proportion of the conductive filler to the current collector is preferably 10% to 50% by weight based on a weight of the current collector.

A thickness of the resin current collector is not particularly limited, but the thickness of the resin current collector is preferably 100 μm or less and more preferably 40 to 80 μm.

In a case where the thickness of the resin current collector is 100 μm or less, particularly 40 to 80 μm, the thickness of the resin current collector is thin, and a thinned resin current collector can be obtained. Since such a resin current collector has a small volume in the battery, it is suitable for increasing battery capacity of the battery.

The thickness of the resin current collector is measured by a thickness of a portion where the recess is not formed.

A metal film may be provided on one principal surface of the resin current collector on a side where the recess is not provided. Examples of a method for providing the metal film include methods such as sputtering, electrodeposition, plating treatment, and coating. Examples of metal species constituting a metal layer include copper, nickel, titanium, silver, gold, platinum, aluminum, stainless steel, and nichrome.

The principal surface of the resin current collector on a side where the recess is not provided is a surface where the resin current collector are in contact with each other in a case where the lithium ion batteries are laminated and used. By providing a metal layer on the surface, contact resistance between the resin current collectors at the time of laminating can be reduced.

It is preferable that the principal surface of the resin current collector in contact with the electrode active material has a conductive filler layer in which a large number of the conductive filler is distributed.

Examples of the conductive filler included in the conductive filler layer include the same conductive fillers included in the resin composition described above.

The conductive filler included in the resin composition and the conductive filler included in the conductive filler layer may be the same type or may be different types.

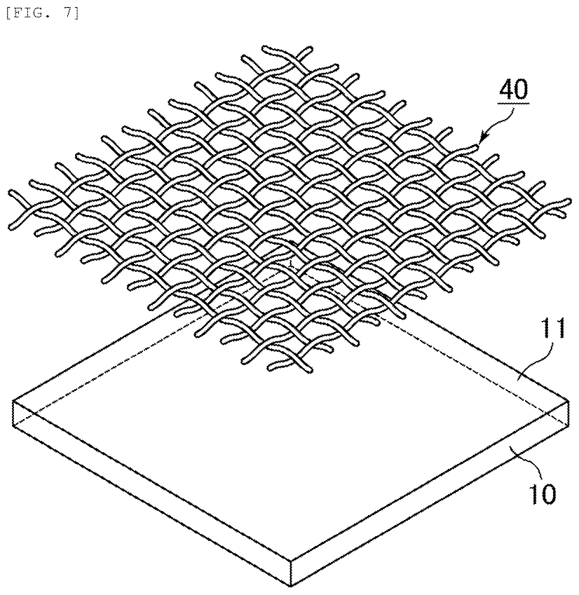

FIG. 6 is a perspective view schematically showing an example of a resin current collector having a conductive filler layer.

A resin current collector 10 shown in FIG. 6 has a conductive filler layer in which a large number of a conductive filler 30 is distributed on a principal surface 11.

The conductive filler layer is not a layer which is observed separately from a resin current collector layer 10, and this means that there is a portion where a large number of the conductive filler 30 is distributed on the principal surface 11 of a resin current collector layer 10.

In a case where there are many conductive fillers on the surface of the principal surface in which the recess is present compared to other portions (for example, a central portion in a thickness direction) of the resin current collector layer in the thickness direction, it can be said that the conductive filler layer is present.

The conductive filler layer may be provided on the surface of the recess in the principal surface of the resin current collector, or may be provided on both the surface of the recess and the surface other than the recess.

In a case where the conductive filler layer is present on the principal surface of the resin current collector in contact with the electrode active material, since sheet resistance of the resin current collector can be further lowered, the contact resistance between the resin current collector and the electrode active material layer can be further lowered.

Further, it is possible to suppress an increase in resistance value due to the repeated charging and discharging.

The electrode active material layer is in contact with the principal surface of the resin current collector which has recesses.

As the electrode active material, positive electrode active material particles or negative electrode active material particles can be used, and the electrode active material is used as coated electrode active material particles in which a part of a surface of a particulate electrode active material particle is coated with a coating layer including a polymer compound.

The electrode for a lithium-ion battery of the present invention may be used as a positive electrode or a negative electrode.

By using positive electrode active material particles, the electrode for a lithium-ion battery is used as a positive electrode.

By using the negative electrode active material particles, the electrode for a lithium-ion battery is used as the positive electrode.

Examples of the positive electrode active material particles include a composite oxide of lithium and a transition metal {a composite oxide having one kind of transition metal (LiCoO₂, LiNiO₂, LiAlMnO₄, LiMnO₂, LiMn₂O₄, or the like), a composite oxide having two kinds of transition metal elements (for example, LiFeMnO₄, LiNi₁₋ₓCoₓO₂, LiMn_{1-y}Co_{y}O₂, LiNi_{1/3}Co_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one examples is LiNi_{1/3}Mn_{1/3}Co_{1/3}O₂)], or the like the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive polymer (for example, polyaniline, polypyrrole, polythiophene, polyacetylene, poly-p-phenylene, or polyvinyl carbazole). Two or more thereof may be used in combination.

Here, the lithium-containing transition metal phosphate may be one in which a part of transition metal sites is substituted with another transition metal.

Examples of the negative electrode active material particles include a carbon-based material [graphite, non-graphitizable carbon, amorphous carbon, a resin sintered product (for example, a sintered product obtained by sintering and carbonizing a phenol resin, a furan resin, or the like), cokes (for example, a pitch coke, a needle coke, and a petroleum coke), carbon fiber, or the like], a silicon-based material [silicon, silicon oxide (SiOx), a silicon-carbon composite body (a composite body obtained by coating surfaces of carbon particles with silicon and/or silicon carbide, a composite body obtained by coating surfaces of silicon particles or silicon oxide particles with carbon and/or silicon carbide, silicon carbide, or the like), a silicon alloy (a silicon-aluminum alloy, a silicon-lithium alloy, a silicon-nickel alloy, a silicon-iron alloy, a silicon-titanium alloy, a silicon-manganese alloy, a silicon-copper alloy, a silicon-tin alloy, or the like), or the like], a conductive polymer (for example, polyacetylene or polypyrrole), a metal (tin, aluminum, zirconium, titanium, or the like), a metal oxide (a titanium oxide, a lithium-titanium oxide, or the like), a metal alloy (for example, a lithium-tin alloy, a lithium-aluminum alloy, or a lithium-aluminum-manganese alloy), or the like, and a mixture of the above and a carbon-based material.

Among them, regarding negative electrode active material particles which do not contain lithium or lithium ions in the inside thereof, a part or all of the negative electrode active material particles may be subjected to pre-doping treatment to incorporate lithium or lithium ions in advance.

Among these, a carbon-based material, a silicon-based material, and a mixture thereof is preferable from the viewpoint of battery capacity and the like. The carbon-based material is more preferably graphite, non-graphitizable carbon, or amorphous carbon, and the silicon-based material is more preferably silicon oxide or a silicon-carbon composite body.

At least a part of the surface of the electrode active material particles is coated with a coating layer including a polymer compound.

In a case where the electrode active material particles are coated electrode active material particles in which at least a part of the surface thereof is coated with the coating layer including a polymer compound, a change in volume of the electrode is alleviated, and expansion of the electrode can be suppressed.

Examples of the polymer compound include a fluororesin, a polyester resin, a polyether resin, a vinyl resin, a urethane resin, a polyamide resin, an epoxy resin, a polyimide resin, a silicone resin, a phenol resin, a melamine resin, a urea resin, an aniline resin, an ionomer resin, polycarbonate, polysaccharide (sodium alginate, or the like), and a mixture thereof.

Further, as the polymer compound, those described as a non-aqueous secondary battery active material coating resin in Japanese Unexamined Patent Application, First Publication No. 2017-054703 can be suitably used.

Among these, a fluororesin, a polyester resin, a polyether resin, a vinyl resin, a urethane resin, a polyamide resin and a mixture thereof are preferable, and a vinyl resin is more preferable, from the viewpoint of wettability to and liquid absorption of an electrolyte solution.

The coating layer preferably includes a conductive auxiliary agent. As the conductive auxiliary agent, the same conductive filler as that exemplified as the conductive filler included in the resin current collector can be used.

The electrode active material layer including the coated electrode active material particles may include a conductive auxiliary agent in addition to the conductive auxiliary agent included in the coating layer of the coated electrode active material particles. As the conductive auxiliary agent, the same conductive auxiliary agent included in the coating layer described above can be suitably used.

The electrode active material layer is preferably a non-bound body that includes the electrode active material and does not include a binding material binding the electrode active materials to each other.

Here, in the non-bound body, position of the electrode active material is not fixed by the binding material (also referred to as a binder), and it means that the electrode active materials, and the electrode active material and the current collector are not irreversibly fixed to each other.

The electrode active material layer may include a pressure-sensitive adhesive resin.

As the pressure-sensitive adhesive resin, it is possible to suitably use, for example, a resin obtained by mixing the non-aqueous secondary battery active material coating resin described in Japanese Unexamined Patent Application, First Publication No. 2017-054703 with a small amount of an organic solvent and adjusting the glass transition temperature thereof to room temperature or lower, and those described as adhesives in Japanese Unexamined Patent Application, First Publication No. H10-255805.

Here, the pressure-sensitive adhesive resin means a resin having pressure-sensitive adhesiveness (an adhering property obtained by applying a slight pressure without using water, solvent, heat, or the like) without solidifying even in a case where a solvent component is volatilized and dried. On the other hand, a solution-drying type electrode binder, which is used as a binding material, means a binder that dries and solidifies in a case where a solvent component is volatilized, thereby firmly adhering and fixing active materials to each other.

As a result, the solution-drying type electrode binder (binding material) and the pressure-sensitive adhesive resin are different materials.

A thickness of the electrode active material layer is not particularly limited, but from the viewpoint of battery performance, is preferably 150 to 600 μm and more preferably 200 to 450 μm.

The electrode for a lithium-ion battery of the present invention can be produced by forming the electrode active material layer including the coated electrode active material particles on the principal surface of the resin current collector which has recesses.

The resin current collector having recesses on the principal surface can be produced, for example, by the following method.

The polymer material constituting the resin current collector, the conductive filler, and other components as necessary are mixed to obtain a material for a resin current collector.

Examples of the mixing method includes a method of obtaining a masterbatch of the conductive filler and then further mixing the masterbatch with the polymer material, a method of using a masterbatch of the polymer material, the conductive filler, and other components as necessary, and a method of collectively mixing all raw materials, and for the mixing thereof, it is possible to use a suitable known mixer with which pellet-shaped or powder-shaped components can be mixed, such as a kneader, an internal mixer, a Banbury mixer, or a roll.

The order of addition of each component at the time of mixing is not particularly limited. The obtained mixture may be further pelletized or powdered by a pelletizer or the like.

The obtained resin composite is formed into, for example, a film shape, whereby the resin current collector is obtained. Examples of the method of forming a material into a film shape include known film forming methods such as a T-die method, an inflation method, and a calendaring method.

Further, two or more types of resin current collector layers may be produced, and they may be stacked and heat-pressed to be integrated to obtain the resin current collector layer as a multi-layer film.

A recess is formed on one principal surface of the obtained resin current collector layer.

The recess can be formed by placing a mesh such as a metal mesh (SUS mesh and the like) and a resin mesh (nitrile mesh and the like) on the one principal surface of the resin current collector layer and heat-pressing from above and below.

In a case where the mesh is removed from the resin current collector layer after the heating press, a recess matching the shape of the mesh is formed on the one principal surface of the resin current collector layer.

FIG. 7 is a perspective view schematically showing a state in which the recess is formed by using a mesh.

A mesh 40 is placed on one principal surface 11 of a resin current collector layer 10′ before forming a recess and pressed to form a recess corresponding to the shape of the mesh.

In a case where a metal mesh or a resin mesh is used, any shape such as plain weave, twill weave, and tatami weave can be used.

A press temperature in the heating press is preferably 110° C. to 160° C. for the upper hot plate and 90° C. to 120° C. for the lower hot plate.

It is preferable to heat from above and below during the heating press. By heating from above and below, the recess can be uniformly formed on one principal surface of the resin current collector layer, and wrinkles can be prevented from occurring in the resin current collector layer.

In a case where the press temperature is too high, the mesh may fuse with the resin current collector layer. Further, in a case where the press temperature is too low, the formation of the recess is insufficient or non-uniform. In addition, the current collector may be wrinkled.

A press time may be a time sufficient to uniformly apply heat to the resin current collector layer, but is preferably 10 to 60 seconds. In a case where the press time is too high, the mesh may fuse with the resin current collector layer. Further, in a case where the press time is too low, the formation of the recess is insufficient or non-uniform.

A press pressure is preferably such that a load on the resin current collector layer is 300 to 1500 kN or 4.8 to 24.0 MPa.

In a case where the load is appropriate, the recess can be uniformly formed on one principal surface of the resin current collector layer, and wrinkles can be prevented from occurring in the resin current collector layer.

In a case where the load is too large, the mesh may bite deeply into the resin current collector layer and may not come off, and the recess may be too deep to reduce strength of the resin current collector. On the other hand, in a case where the load is too small, the formation of the recess is insufficient or non-uniform. In addition, the resin current collector layer may be wrinkled.

At the same time as the formation of the recess, or before and after the formation of the recess, a conductive filler layer can be formed.

By attaching a conductive filler to the mesh for forming the recess and heat-pressing the conductive filler so that the conductive filler touches the resin current collector layer, the conductive filler can be attached to the surface of the recess. In this case, the conductive filler layer is formed on the surface of the recess.

A method of attaching the conductive filler to the mesh is not particularly limited, and examples thereof include a method of pressing the mesh against the conductive filler, a method of applying static electricity to the resin mesh to charge the resin mesh and attaching a carbon-based filler, and a method of spraying the conductive filler dispersed in a solution of methanol onto the mesh to attach the conductive filler.

Further, by applying a dispersion liquid in which the conductive filler is dispersed in a solution to the principal surface of the resin current collector layer and drying the dispersion liquid, the conductive filler layer can be formed on the principal surface of the resin current collector layer.

Thereafter, the recess can be formed on the principal surface on which the conductive filler layer is formed.

In this case, the conductive filler layer is formed on both the surface of the recess and the surface other than the recess.

A dispersing agent may be used to disperse the conductive filler in the solution. The dispersing agent is not particularly limited, but a dispersing agent which can withstand a voltage in the lithium ion battery electrode is preferable. Among dispersing agents, examples of a dispersing agent which exhibits appropriate dispersion, can withstand voltage, and is soluble in an organic solvent include N-vinylpyrrolidone and a copolymer of acrylic acid and (meth)acrylic acid ester.

The resin current collector having recesses on the principal surface can be produced by the above-described method.

The coated electrode active material particles can be obtained by coating the electrode active material particles with a polymer compound. For example, the coated electrode active material particles can be obtained by putting the electrode active material particles in an all-purpose mixer and stirring the mixture, adding dropwise and mixing a resin solution including the polymer compound, mixing the conductive filler as necessary, raising the temperature while stirring, reducing the pressure, and maintaining the mixture for a predetermined time.

The coated electrode active material particles obtained above in such a manner are mixed with an electrolyte solution or a solvent, and the conductive filler added thereto as necessary to produce a slurry. Thereafter, by applying the above-described slurry to the principal surface of the resin current collector having a plurality of recesses and drying the slurry to form an electrode active material layer, the electrode for a lithium-ion battery can be produced.

Further, the electrode active material layer can be formed on the resin current collector by mixing the coated electrode active material particles with the conductive auxiliary agent to prepare an electrode active material layer precursor and pressing the electrode active material layer precursor on the resin current collector. Thereby, the electrode for a lithium-ion battery can be produced.

Further, an electrolyte solution may be added to the electrode active material layer of the obtained electrode for a lithium-ion battery.

A lithium ion battery can be produced using the lithium ion battery electrode.

The lithium ion battery is obtained by combining electrodes to be counter electrodes, housing the electrodes together with a separator in a cell container, injecting an electrolyte solution, and sealing the cell container.

Examples of the separator include known separators for a lithium-ion battery, such as a porous film made of polyethylene or polypropylene, a lamination film of a porous polyethylene film and a porous polypropylene, a non-woven fabric made of a synthetic fiber (a polyester fiber, an aramid fiber, or the like), a glass fiber, or the like and those above of which the surface is attached with ceramic fine particles such as silica, alumina, and titania.

A known electrolyte solution can be used as the electrolyte solution.

As an electrolyte, an electrolyte used in the known electrolyte solution can be used, and examples thereof include lithium salts of inorganic anion, such as LiPF₆, LiBF₄, LiSbF₆, LiAsF₆, LiClO₄, and LiN(FSO₂)₂, and lithium salts of organic anion, such as LiN(CF₃SO₂)₂, LiN(C₂F₅SO₂)₂, and LiC(CF₃SO₂)₃. Among these, LiN(FSO₂)₂ is preferable from the viewpoints of battery output and charging and discharging cycle characteristics.

As the solvent, a non-aqueous solvent used in the known electrolyte solution can be used, and for example, a lactone compound, a cyclic or chain-like carbonic acid ester, a chain-like carboxylic acid ester, a cyclic or chain-like ether, a phosphoric acid ester, a nitrile compound, an amide compound, a sulfone, a sulfolane, or a mixture thereof can be used.

### EXAMPLES

Next, the present invention will be specifically described with reference to Examples; however, the present invention is not limited to Examples without departing from the gist of the present invention. Unless otherwise specified, parts mean parts by weight and % means % by weight.

### Production of Resin Current Collector Layer

### Production Example 1

75 parts of a polypropylene resin as a polymer material, 20 parts of acetylene black as a conductive filler, and 5 parts of a dispersing agent [product name “UMEX 1001 (an acid-modified polypropylene)”, manufactured by Sanyo Chemical Industries, Ltd.] were melted and kneaded with a twin-screw extruder under the conditions of 180° C., 100 rpm, and a residence time of 5 minutes, whereby a resin composition was obtained.

The obtained resin composition was extruded from a T-die and rolled with a cooling roll of which the temperature was adjusted to 50° C., whereby a resin current collector layer (L-1) was obtained. A thickness of the obtained resin current collector layer was 50 μm.

### Production Example 2

A resin current collector layer (L-2) was obtained by using a composition having the composition shown in Table 1-1 as the resin composition in the resin current collector layer (L-1).

### Production Example 3

A resin current collector layer (L-3) as a multi-layer film was obtained by stacking and heat-pressing the resin current collector layer (L-1) and the resin current collector layer (L-2) at 160° C. to be integrated.

### Production Example 4

A resin current collector layer (L-4) was obtained by forming metal layer made of platinum on one principal surface of the resin current collector layer (L-3) by sputtering.

For the resin current collector layers (L-1) to (L-4), a thickness, a surface roughness (Ra), a penetration resistance value, and a breaking stress were determined.

For (L-4), the surface roughness of the surface on which the metal layer was not formed was measured.

The thickness of the resin current collector layer was measured using a film thickness meter [manufactured by Mitutoyo Corporation].

A method for measuring the penetration resistance value is as follows.

These physical properties are summarized in Table 1-1.

[Measurement of penetration resistance value] The resin current collector layers were punched to φ15 mm, and the penetration resistance value of each of the resin current collector layers was measured using an electric resistance measuring instrument [IMC-0240 type, manufactured by Imoto Machinery Co., Ltd.] and a resistance meter [RM3548, manufactured by HIOKI E.E. Corporation].

The resistance value of the resin current collector layer was measured in a state in which a load of 2.16 kg was applied to the electric resistance measuring instrument, and a value 60 seconds after the load of 2.16 kg was applied was taken as the resistance value of the resin current collector layer. As indicated in the expression below, a value obtained by multiplying the area (1.77 cm²) of the contact surface of the jig at the time of resistance measurement was used as the penetration resistance value (Ω)·cm²).

Penetration resistance value (Ω·cm²)=resistance value (Ω)×1.77 (cm²)

[Measurement of breaking stress] The resin current collector layer was molded with a dumbbell punching machine according to JIS K 7127, the sample was fixed to a 1 kN load cell fixed to an autograph [AGS-X10 kN manufactured by Shimadzu Corporation] and a grip for a tensile test, and the breaking stress (MPa) was defined as a value obtained by dividing a test force at a breaking point pulled at a speed of 100 mm/min by a cross-sectional area of a fracture surface.

Breaking stress (MPa)=test force (N)/(film thickness (mm)×10 (mm))

TABLE 1-1

| | | | Production | Production | Production | Production |
|---|---|---|---|---|---|---|
| | | | Example 1 | Example 2 | Example 3 | Example 4 |
| Resin current collector | | | L-1 | L-2 | L-3 | L-4 |
| Resin | Polymer | Polypropylene | 75 | 70 | L-1 + L-2 | Pt film is |
| composition | material | resin [part | | | | formed on |
| | | by weight] | | | | one side of |
| | Conductive | Acetylene | 20 | 25 | | L-3 |
| | filler | black [part | | | | |
| | | by weight] | | | | |
| | Dispersing | UMEX [part | 5 | 5 | | |
| | agent | by weight] | | | | |

| | | | | | |
|---|---|---|---|---|---|
| Physical | Thickness [μm] | 50 | 48 | 72 | 72 |
| properties | Ra [μm] | 0.4 | 0.6 | 0.8 | 0.8 |
| of resin | Penetration resistance | 10 | 8.5 | 13.1 | 10.9 |
| current | value [Ω · cm²] | | | | |
| collector | Breaking stress [MPa] | 40 | 36 | 37 | 36 |

### Formation of Recess on Resin Current Collector

### Production Example 5

A plain weave SUS 316 mesh having a mesh size of 77 μm and a wire diameter of 50 μm was placed on the resin current collector layer (L-1), the laminate was set in a tabletop test press machine [SA-302, manufactured by TESTER SANGYO CO,. LTD.] in which a temperature of upper table was adjusted to 160° C. and a temperature of lower table was adjusted to 100° C., and a pressure was adjusted so that a load on the resin current collector layer was 2.4 MPa to perform pressing for 60 seconds. In this case, a press load was 150 kN.

After the pressing, the resin current collector layer was taken out from the press machine, and the mesh was peeled off to obtain a resin current collector (S-1) having recesses. A shape of the obtained recess was an elliptical shape as seen from above as shown in FIG. 3, a shape of the recess having a major axis in the horizontal direction was a semi-elliptical sphere having a horizontal length/vertical length/depth of 51 μm/20 μm/5 μm, respectively, and a shape of the recess having a major axis in the vertical direction was a semi-elliptical sphere having a horizontal length/vertical length/depth of 18 μm/43 μm/3 μm, respectively.

A proportion of an area of the recess as seen from above was 17% with respect to an area of a surface of the resin current collector provided with the recess as seen from above.

### Production Example 6

A current collector having recesses was obtained in the same manner as in Production Example 5, except that the type of the resin current collector layer was changed to (L-2), and the type of the mesh was changed to the mesh shown in Table 1-2. Production conditions of the resin current collector and specifications of the obtained current collector are shown in Table 1-2.

### Production Example 7

A resin current collector (S-3) having recesses was obtained in the same manner as in Production Example 5, except that, on the resin current collector layer (L-1), a CNF-adhered mesh in which carbon nanofiber (product name “VGCF-H”, manufactured by Showa Denko K.K.; hereafter, abbreviated as CNF) was brought into contact with a pre-charged plain weave nitrile mesh having a mesh size of 70 μm and a wire diameter of 70 μm was placed and the press load was changed. Production conditions of the resin current collector and specifications of the obtained current collector are shown in Table 1-2.

### Production Example 8

On the resin current collector layer (L-1), a CNF dispersion liquid ultrasonically dispersed in a solution in which 0.6 parts of CNF and 0.1 parts of a polymer dispersing agent were dissolved in 30 parts of methanol was applied with a coater having a thickness of 100 μm, and was naturally dried in an atmosphere of 25° C. to obtain a resin current collector layer to which the conductive filler was uniformly applied. Pressing was performed in the same manner as in Production Example 5 to obtain a resin current collector (S-4) having recesses, except that a resin current collector to which the conductive filler was uniformly applied was used and the press load was changed. Production conditions of the resin current collector and specifications of the obtained current collector are shown in Table 1-2.

### Production Example 9

The type of the resin current collector layer was changed to (L-3), and the same type of mesh as in Production Example 5 was used: a resin current collector (S-5) having recesses was obtained in the same manner as in Production Example 5, except that an AB-adhered mesh with acetylene black (hereinafter, abbreviated as AB) adhered to the mesh was placed and the press load was changed. Production conditions of the resin current collector and specifications of the obtained current collector are shown in Table 1-2.

### Production Example 10

A resin current collector (S-6) having recesses was obtained in the same manner as in Production Example 5, except that the type of the resin current collector layer was changed to (L-4) and the type of the mesh was changed to the mesh shown in Table 1-2, a Ni-adhered mesh to which nickel particles (hereinafter, abbreviated as Ni) were adhered was placed on the mesh, and the press load was changed. Production conditions of the resin current collector and specifications of the obtained current collector are shown in Table 1-2.

For the resin current collectors having recesses that are obtained in each Production Example, the penetration resistance value and the breaking stress were determined. The results are summarized in Table 1-2.

TABLE 1-2

| Resin current collector | Production | Production | Production | Production | Production | Production |
|---|---|---|---|---|---|---|
| having recesses formed | Example 5 | Example 6 | Example 7 | Example 8 | Example 9 | Example 10 |
| thereon | S-1 | S-2 | S-3 | S-4 | S-5 | S-6 |
| Resin current collector | L-1 | L-2 | L-1 | L-2 | L-3 | L-4 |
| Added conductive filler | — | — | CNF | CNF | AB | Ni |
| Mesh size of mesh [μm] | 77 | 26 | 70 | 77 | 77 | 283 |
| Wire diameter of mesh | 50 | 25 | 70 | 50 | 50 | 140 |
| [μm] | | | | | | |
| Material and weaving | SUS 316 | SUS 316 | Nitrile | SUS 316 | SUS 316 | SUS 304 |
| method of mesh | plain | twill | plain | plain | plain | plain |
| | weave | weave | weave | weave | weave | weave |
| Press temperature | 160/100 | 160/100 | 160/110 | 160/110 | 160/110 | 160/110 |
| (upper/lower) [° C.] | | | | | | |
| Press load (kN) | 150 | 300 | 1000 | 1500 | 1500 | 1500 |
| Horizontal length/vertical | 51/20/5 | 84/23/21 | 119/46/19 | 141/67/27 | 132/69/36 | 279/102/42 |
| length/depth of recess having | | | | | | |
| major axis in horizontal | | | | | | |
| direction [μm] | | | | | | |
| Horizontal length/vertical | 18/43/3 | 20/56/18 | 41/83/13 | 67/138/21 | 52/121/38 | 105/247/41 |
| length/depth of | | | | | | |
| recess having major axis in | | | | | | |
| vertical direction [μm] | | | | | | |
| Proportion of area of recess | 17 | 27 | 23 | 27 | 17 | 36 |
| as seen from above [%] | | | | | | |
| Penetration resistance | 12 | 11 | 16 | 12 | 13 | 12 |
| value [Ω · cm²] | | | | | | |
| Breaking stress [MPa] | 37 | 34 | 38 | 34 | 34 | 32 |

The following dimensions are used as the dimensions used to determine the satisfaction of the relational expression between the maximum depth D and the length S of the recess of the resin current collector and the particle size R of the electrode active material particles.

For the depth D, the smaller dimension out of the depth of the recess having the major axis in the horizontal direction and the depth of the recess having the major axis in the vertical direction is defined as the depth D.

For the length S, the smallest dimension of four lengths, i.e., the horizontal length and the vertical length of the recess having the major axis in the horizontal direction, and the horizontal length and the vertical length of the recess having the major axis in the vertical direction, is defined as the length S.

### Synthesis of Polymer Compound

### Production Example 11

90 parts of 2-ethylhexyl acrylate, 5 parts of isobutyl methacrylate, 4.6 parts of methacrylic acid, 0.4 parts of 1,6-hexanediol dimethacrylate, and 390 parts of toluene were charged into a four-necked flask equipped with a stirrer, a thermometer, a reflux condenser, a dropping funnel, and a nitrogen gas introduction tube, and the temperature was raised to 75° C. 10 parts of toluene, 0.200 parts of 2,2′-azobis(2,4-dimethylvaleronitrile), and 0.200 parts of 2,2′-azobis(2-methylbutyronitrile) were mixed. The obtained monomer mixture solution was continuously added dropwise to the flask over 4 hours with a dropping funnel, while blowing nitrogen thereto, to carry out radical polymerization. After the completion of the dropwise addition, a solution prepared by dissolving 0.800 parts of 2,2′-azobis(2,4-dimethylvaleronitrile) in 12.4 parts of toluene was continuously added thereto using a dropping funnel at 6 to 8 hours after the start of polymerization. Further, the polymerization was continued for 2 hours, and 488 parts of toluene was added thereto to obtain a solution of a polymer compound (P-1), having a resin solid content concentration of 30% by weight.

### Production Examples 12 to 14

Solutions of the coating resins (P-2) to (P-4) were obtained by changing the monomer compositions of the polymer compounds as shown in Table 1-3.

For the coating resins (P-1) to (P-2), a molecular weight (Mw) and a glass transition temperature were determined. These physical properties are summarized in Table 1-3.

TABLE 1-3

| | | Production | Production | Production | Production |
|---|---|---|---|---|---|
| | | Example 11 | Example 12 | Example 13 | Example 14 |
| Coating resin | | P-1 | P-2 | P-3 | P-4 |
| Part by weight of monomer | 2-Ethylhexyl acrylate | 90 | — | — | — |
| of polymer compound | Lauryl methacrylate | — | 95 | 25 | — |
| | Isobutyl methacrylate | 5 | — | — | — |
| | Methyl methacrylate | — | — | 5 | 9 |
| | Methacrylic acid | 4.6 | 4.6 | 70 | — |
| | Acrylic acid | — | — | — | 91 |
| | 1,6-Hexanediol | 0.4 | 0.4 | — | — |
| | dimethacrylate | | | | |
| Physical properties | Molecular weight (Mw) | 98000 | 85000 | 71000 | 75000 |
| | Glass transition | 22 | −50 | 190 | 97 |
| | temperature [° C.] | | | | |

### Preparation of Electrolyte Solution

LiN(FSO₂)₂(LiFSI) was dissolved in a mixed solvent of ethylene carbonate (EC) and propylene carbonate (PC) (EC:PC=1:1 in terms of volume ratio) at a rate of 2 mol/L, whereby an electrolyte solution for a lithium-ion battery was prepared.

### Preparation of Coated Positive Electrode Active Material Particles

### Production Example 15

Coated positive electrode active material particles for a lithium-ion battery using the solution of the coating resin (P-1) as a resin solution was produced by the following method.

94 parts of LiNi_{0.8}Co_{0.15}Al_{0.05}O₂ [manufactured by TODA KOGYO CORP., volume average particle diameter (D50 particle size): 6.5 μm, denoted as NCA in Table 1-4] as a positive electrode active material was put into an all-purpose mixer, High Speed Mixer FS25 [manufactured by EARTHTECHNICA Co., Ltd.], the above-described resin solution was added dropwise thereto over 2 minutes with stirring at room temperature and 720 rpm, and the mixture was further stirred for 5 minutes.

Next, in a state of the mixture being stirred, 3 parts of acetylene black [DENKA BLACK (registered trade name) manufactured by Denka Company Limited] was divisionally added as a conductive auxiliary agent in 2 minutes, and stirring was continued for 30 minutes. Thereafter, the pressure was reduced to 0.01 MPa while maintaining the stirring, the temperature was subsequently raised to 150° C. while maintaining the stirring and the degree of pressure reduction, and the stirring, the degree of pressure reduction, and the temperature were maintained for 8 hours to distill off volatile matter. The obtained powder was classified with a sieve having a mesh size of 212 μm to obtain a coated positive electrode active material (CM-1).

### Production Examples 16 to 17

Coated positive electrode active material particles (CM-2) to (CM-3) were obtained in the same manner as in Production Example 15, except that the parts by weight of the positive electrode active material particles, the type and parts by weight of the coating resin, and the parts by weight of acetylene black were changed as shown in Table 1-4.

### Production Examples 18 to 19

LiNi_{0.8}Co_{0.15}Al_{0.05}O₂ [manufactured by TODA KOGYO CORP., volume average particle diameter (D50 particle size): 14.2 μm] was used in the parts by weight shown in Table 1-4 as a positive electrode active material.

Coated positive electrode active material particles (CM-4) to (CM-5) were obtained in the same manner as in Production Example 15, except that the type and parts by weight of the coating resin and the parts by weight of acetylene black were changed as shown in Table 1-4.

For the coated positive electrode active material particles (CM-1) to (CM-5), the D50 particle size, tap density and powder resistance were determined. These physical properties are summarized in Table 1-4.

The D50 particle size of the coated positive electrode active material particles was determined by the microtrack method (laser diffraction/scattering method).

The tap density of the coated positive electrode active material particles was measured in accordance with JIS K 5101-12-2 (2004), using a cylindrical container with a capacity of 100 cm³ and a diameter of 30 mm, a drop height of 5 mm, and the number of tamps (also referred to as tap or tapping) of 2000 times.

The powder resistance of the coated positive electrode active material particles was determined as a measured value at a load of 5 kN using a powder resistance measuring system MCP-PD51 [manufactured by Mitsubishi Chemical Analytech Co., Ltd.].

TABLE 1-4

| | | | Production | Production | Production | Production | Production |
|---|---|---|---|---|---|---|---|
| Coated positive electrode | | | Example 15 | Example 16 | Example 17 | Example 18 | Example 19 |
| active material particles | | | CM-1 | CM-2 | CM-3 | CM-4 | CM-5 |
| Part by weight of | NCA | D50 | 94 | 91 | 96 | — | — |
| positive electrode | | particle size: | | | | | |
| active material | | 6.5 μm | | | | | |
| particles | | D50 | — | — | — | 94 | 91 |
| | | particle size: | | | | | |
| | | 14.2 μm | | | | | |

| | | | | | | |
|---|---|---|---|---|---|---|
| Part by weight of | P-1 | 3 | — | — | 3 | — |
| coating resin | P-2 | — | 3 | — | — | 2 |
| | P-3 | — | — | 1 | — | — |
| | P-4 | — | — | — | — | 1 |
| Part by weight of | Acetylene black | 3 | 6 | 3 | 3 | 6 |
| conductive | | | | | | |
| auxiliary agent | | | | | | |
| Characteristics | D50 particle size (μm) | 9.8 | 12.1 | 7.1 | 20.2 | 16.3 |
| of coated positive | Tap density (g/cm³) | 2.4 | 1.9 | 2.7 | 1.4 | 2.4 |
| electrode active | Powder resistance (Ω/cm) | 3.1 | 1.9 | 2.8 | 3.4 | 1.7 |
| material particles | | | | | | |

### [Production of Coated Negative Electrode Active Material] (Production Example 20)

A coated negative electrode active material for a lithium-ion battery using the solution of the coating resin (P-3) as a resin solution was produced by the following method.

94 parts of non-graphitizable carbon [CARBOTRON (registered trade name) PS(F), volume average particle diameter (D50 particle size): 4.6 μm, manufactured by Kureha Battery Materials Japan Co., Ltd., denoted as HC in Table 1-5] as negative electrode active material particles was put into an all-purpose mixer, High Speed Mixer FS25 [manufactured by EARTHTECHNICA Co., Ltd.], the above-described resin solution was added dropwise thereto over 2 minutes so that the solid content weight is 3 parts with stirring at room temperature and 720 rpm, and the mixture was further stirred for 5 minutes.

Next, in a state of the mixture being stirred, 3 parts of acetylene black [DENKA BLACK (registered trade name) manufactured by Denka Company Limited] was divisionally added as a conductive auxiliary agent in 2 minutes, and stirring was continued for 30 minutes. Thereafter, the pressure was reduced to 0.01 MPa while maintaining the stirring, the temperature was subsequently raised to 150° C. while maintaining the stirring and the degree of pressure reduction, and the stirring, the degree of pressure reduction, and the temperature were maintained for 8 hours to distill off volatile matter. The obtained powder was classified with a sieve having a mesh size of 212 μm to obtain a coated negative electrode active material (AM-1).

### Production Examples 21 to 22

Non-graphitizable carbon [CARBOTRON (registered trade name) PS(F), volume average particle diameter (D50 particle size): 20.1 μm, manufactured by Kureha Battery Materials Japan Co., Ltd.] was used in the parts by weight shown in Table 1-5 as negative electrode active material particles.

Coated negative electrode active material particles (AM-2) to (AM-3) were obtained in the same manner as in Production Example 15, except that the type and parts by weight of the coating resin and the parts by weight of acetylene black were changed as shown in Table 1-5.

### Production Examples 23 to 24

Non-graphitizable carbon [CARBOTRON (registered trade name) PS(F), volume average particle diameter (D50 particle size): 24.7 μm, manufactured by Kureha Battery Materials Japan Co., Ltd.] was used in the parts by weight shown in Table 1-5 as negative electrode active material particles.

Coated negative electrode active material particles (AM-4) to (AM-5) were obtained in the same manner as in Production Example 15, except that the type and parts by weight of the coating resin and the parts by weight of acetylene black were changed as shown in Table 1-5.

For the coated negative electrode active material particles (AM-1) to (AM-5), the D50 particle size, tap density and powder resistance were determined in the same manner as in the coated positive electrode active material particles . These physical properties are summarized in Table 1-5.

TABLE 1-5

| | | | Production | Production | Production | Production | Production |
|---|---|---|---|---|---|---|---|
| Coated negative electrode | | | Example 20 | Example 21 | Example 22 | Example 23 | Example 24 |
| active material particles | | | AM-1 | AM-2 | AM-3 | AM-4 | AM-5 |
| Part by weight of | HC | D50 | 94 | — | — | — | — |
| negative electrode | | particle size: | | | | | |
| active material | | 4.6 μm | | | | | |
| particles | | D50 | — | 94 | 92 | — | — |
| | | particle size: | | | | | |
| | | 20.1 μm | | | | | |
| | | D50 | — | — | — | 94 | 91 |
| | | particle size: | | | | | |
| | | 24.7 μm | | | | | |

| | | | | | | |
|---|---|---|---|---|---|---|
| Part by weight of | P-1 | — | — | — | — | — |
| coating resin | P-2 | — | — | — | — | 2 |
| | P-3 | 3 | 3 | — | — | — |
| | P-4 | — | — | 2 | 3 | 1 |
| Part by weight of | Acetylene black | 3 | 3 | 6 | 3 | 6 |
| conductive | | | | | | |
| auxiliary agent | | | | | | |
| Characteristics | D50 particle size (μm) | 6.2 | 24.2 | 21.5 | 33.1 | 46.3 |
| of coated negative | Tap density (g/cm³) | 0.89 | 0.91 | 0.86 | 0.87 | 0.81 |
| electrode active | Powder resistance (Ω/cm) | 0.18 | 0.23 | 0.19 | 0.24 | 0.34 |
| material particles | | | | | | |

### Production of Positive Electrode Active Material Layer and Positive Electrode

### Example 1-1

A positive electrode active material layer was formed on the principal surface of the resin current collector layer having recesses to produce a positive electrode.

Specifically, 1 part of carbon nanofiber (product name “VGCF-H”, manufactured by Showa Denko K.K.) was mixed at 2000 rpm for 5 minutes using a planetary stirring type mixing and kneading device {Awatori Rentaro [manufactured by THINKY Corporation] }, and after adding 99 parts of the coated positive electrode active material particles (CM-1), the mixture was further mixed with the Awatori Rentaro at 2000 rpm for 2 minutes to produce a positive electrode active material layer precursor.

A cylindrical mold of 15 mmφ×50 mm was placed on the principal surface of the resin current collector (S-4) having recesses to put the obtained positive electrode active material layer precursor into the cylindrical mold so that the amount of active material was 80 mg/cm². Next, a cylindrical column of 15 mmφ×50 mm was pressed to the cylindrical mold at a pressure of 0.1 MPa for 10 seconds, and after that 1.4 MPa for approximately 10 seconds to form a positive electrode active material layer.

Further, the electrolyte solution was added at a rate of 18 parts by weight with respect to 132 parts by weight of the positive electrode active material layer to produce a positive electrode for a lithium-ion battery.

### Example 1-2

A positive electrode for a lithium-ion battery was produced in the same manner as in Example 1-1 except that the resin current collector was changed from (S-4) to (S-5).

### Example 1-3

A positive electrode for a lithium-ion battery was produced in the same manner as in Example 1-1 except that the resin current collector was changed from (S-4) to (S-6), the coated positive electrode active material particles were changed from (CM-1) to (CM-2), and the weight part of the coated positive electrode active material particles and the weight part of the conductive auxiliary agent were changed as shown in Table 1-6.

### Example 1-4

8 parts of 25% N-methylpyrrolidone solution of PVdF and 1 part of carbon nanofiber (product name “VGCF-H”, manufactured by Showa Denko K.K.) were mixed at 2000 rpm for 5 minutes using a planetary stirring type mixing and kneading device {Awatori Rentaro [manufactured by THINKY Corporation]}. Subsequently, after adding 70 parts of N-methylpyrrolidone and 97 parts of the coated positive electrode active material particles (CM-3), the mixture was further mixed with the Awatori Rentaro at 2000 rpm for 2 minutes to obtain a positive electrode slurry. The obtained positive electrode slurry was applied to the principal surface of the resin current collector having recesses so that the amount of active material was 80 mg/cm², and dried under reduced pressure at 100° C. and −0.1 MPa for 3 hours. After pressing the dried electrode composition at a pressure of 1.4 MPa for about 10 seconds, 70 parts of the electrolytic solution was added to the surface of the electrode composition to prepare a positive electrode for a lithium-ion battery.

### Examples 1-5 to 1-6 and Comparative Examples 1-1 to 1-3

A positive electrode for a lithium-ion battery was produced in the same manner as in Example 1-1 except that the type of the resin current collector and the type of the coated positive electrode active material particles were changed as shown in Table 1-6.

### Measurement of Electrode Sliding Angle

For the obtained positive electrode for a lithium-ion battery, the angle at which the electrode active material layer slides off the resin current collector was measured by tilting the electrode. In the positive electrodes of Examples 1-1 to 1-6, the electrode active material layer did not slide off the resin current collector even when the electrode was tilted 180°. On the other hand, in the positive electrodes of Comparative Examples 1-1 to 1-3, the electrode active material layer slipped off the resin current collector.

### Production of Lithium-Ion Battery

The obtained positive electrode was combined with a counter electrode Li metal through a separator (#3501 manufactured by Celgard, LLC), and the electrolyte solution was injected to produce a laminated cell.

### Measurement of Internal Resistance

At 45° C., the positive electrode for a lithium-ion battery was evaluated by the following method using a charging and discharging measuring device “HJ-SD8” [manufactured by HOKUTO DENKO Corporation].

After charging to 4.2 V by a constant current and constant voltage method (0.1 C) and resting for 10 minutes, the battery was discharged to 2.6 V by a constant current method (0.1 C). The voltage and current after 0 seconds of discharge at 0.1 C and the voltage and current after 10 seconds of discharge at 0.1 C were measured by the constant current and constant voltage method (also referred to as a CCCV mode), and the internal resistance was calculated by the following expression. As the internal resistance is smaller, battery characteristics are better.

The voltage after 0 seconds of discharge is a voltage measured at the same time as discharge (also referred to as a discharge voltage).

[Internal resistance (Ω·cm²)]=[(voltage after 0 seconds of discharge at 0.1 C)−(voltage after 10 seconds of discharge at 0.1 C)]÷[(current after 0 seconds of discharge at 0.1 C)−(current after 10 seconds of discharge at 0.1 C)]×[facing surface area (cm²) of electrodes] For the measurement of the internal resistance, a repeated test of 10 cycles was carried out, and the 2-cycle internal resistance and the 10-cycle internal resistance were compared to determine the “10-cycle/2-cycle internal resistance increase rate (%)”.

### Measurement of Capacity Retention Rate

At 45° C., a charging and discharging test was performed on the lithium-ion battery by the following method using a charging and discharging measuring device “HJ-SD8” [manufactured by HOKUTO DENKO Corporation]. The results are shown in Table 1-4.

After charging to 4.2 V by a constant current and constant voltage method (0.1 C) and resting for 10 minutes, the battery was discharged to 2.6 V by a constant current method (0.1 C).

A repeated test of 10 cycles was carried out to determine a 10-cycle capacity retention rate (%).

The evaluation results of the electrode sliding angle, the 10-cycle/2-cycle internal resistance increase rate, and the 10-cycle capacity retention rate for each of Examples and Comparative Examples are summarized in Table 1-6.

TABLE 1-6

| | | | Examples | | | | | | Comparative Examples | | |
|---|---|---|---|---|---|---|---|---|---|---|---|
| Positive electrode | | | 1-1 | 1-2 | 1-3 | 1-4 | 1-5 | 1-6 | 1-1 | 1-2 | 1-3 |
| Resin current collector | | | S-4 | S-5 | S-6 | S-4 | S-6 | S-5 | L-1 | S-1 | S-2 |
| Electrode active | Part by weight of | CM-1 | 99 | 99 | — | — | — | — | — | 99 | — |
| material layer | coated positive | CM-2 | — | — | 98.5 | — | — | — | — | — | — |
| | electrode active | CM-3 | — | — | — | 97 | — | — | — | — | — |
| | material particles | CM-4 | — | — | — | — | 99 | — | 99 | — | 99 |
| | | CM-5 | — | — | — | — | — | 99 | — | — | — |
| | Part by weight of | PVdF | — | — | — | 2 | — | — | — | — | — |
| | polymer compound | | | | | | | | | | |
| | Part by weight of | CNF | 1 | 1 | 1.5 | 1 | 1 | 1 | 1 | 1 | 1 |
| | conductive auxiliary | | | | | | | | | | |
| | agent | | | | | | | | | | |

| | | | | | | | | | |
|---|---|---|---|---|---|---|---|---|---|
| Electrode sliding angle | 180 | 180 | 180 | 180 | 180 | 180 | 28 | 41 | 32 |
| 10-cycle/2-cycle internal | 14.5 | 12.2 | 10.3 | 11.9 | 11.1 | 11.3 | 21.1 | 23.2 | 20.9 |
| resistance increase rate (%) | | | | | | | | | |
| 10-cycle capacity retention rate (%) | 91.7 | 92.2 | 93.1 | 91.2 | 93.8 | 92.1 | 90.3 | 88.5 | 88.9 |

The above evaluation results shows that the positive electrodes of Examples 1-1 to 1-6 have excellent pressure-sensitive adhesiveness between the resin current collector and the electrode active material layer, and also have excellent cycle characteristics.

### Production of Negative Electrode Active Material Layer and Negative Electrode

### Example 1-7

A negative electrode active material layer was formed on the principal surface of the resin current collector layer having recesses to produce a negative electrode.

Specifically, 2 parts of carbon nanofiber (product name “VGCF-H”, manufactured by Showa Denko K.K.) was mixed at 2000 rpm for 5 minutes using a planetary stirring type mixing and kneading device {Awatori Rentaro [manufactured by THINKY Corporation]}, and after adding 98 parts of the coated negative electrode active material particles (AM-1), the mixture was further mixed with the Awatori Rentaro at 2000 rpm for 2 minutes to produce a negative active material layer precursor.

A cylindrical mold of 16 mmφ×50 mm was placed on the principal surface of the resin current collector (S-3) having recesses to put the obtained positive electrode active material layer precursor into the cylindrical mold so that the amount of active material was 34 mg/cm². Next, a cylindrical column of 16 mmφ×50 mm was pressed to the cylindrical mold at a pressure of 0.1 MPa for 10 seconds, and after that 1.4 MPa for approximately 10 seconds to form a negative electrode active material layer.

Further, the electrolyte solution was added at a rate of 18 parts by weight with respect to 132 parts by weight of the negative electrode active material layer to produce a negative electrode for a lithium-ion battery.

### Examples 1-8 to 1-9

A negative electrode for a lithium-ion battery was produced in the same manner as in Example 1-7 except that the type of the resin current collector, the type of the coated negative electrode active material particles, the weight part of the coated negative electrode active material particles and the weight part of the conductive auxiliary agent were changed as shown in Table 1-7.

### Example 1-10

100 parts of 1% CMC solution and 1 part of carbon nanofiber (product name “VGCF-H”, manufactured by Showa Denko K.K.) were mixed at 2000 rpm for 5 minutes using a planetary stirring type mixing and kneading device {Awatori Rentaro [manufactured by THINKY Corporation]}. Subsequently, after adding 7.5 parts of 40% SBR water dispersion and 97 parts of the coated negative electrode active material particles (CM-3), the mixture was further mixed with the Awatori Rentaro at 2000 rpm for 2 minutes to obtain a positive electrode slurry. The obtained negative electrode slurry was applied to the principal surface of the resin current collector having recesses so that the amount of active material was 34 mg/cm², and dried under reduced pressure at 100° C. and −0.1 MPa for 3 hours. After pressing the dried electrode composition at a pressure of 1.4 MPa for about 10 seconds, 70 parts of the electrolytic solution was added to the surface of the electrode composition to prepare a negative electrode for a lithium-ion battery.

### Example 1-11, Comparative Examples 1-4 to 1-7

A negative electrode for a lithium-ion battery was produced in the same manner as in Example 1-7 except that the type of the resin current collector, the type of the coated negative electrode active material particles, the weight part of the coated negative electrode active material particles and the weight part of the conductive auxiliary agent were changed as shown in Table 1-7.

### Measurement of Electrode Sliding Angle

For the obtained negative electrode for a lithium-ion battery, the angle at which the electrode active material layer slides off the resin current collector was measured by tilting the electrode. In the negative electrodes of Examples 1-7 to 1-11, the electrode active material layer did not slide off the resin current collector even when the electrode was tilted 180°. On the other hand, in the negative electrodes of Comparative Examples 1-4 to 1-7, the electrode active material layer slipped off the resin current collector.

### Production of Lithium-Ion Battery

The obtained negative electrode was combined with a counter electrode Li metal through a separator (#3501 manufactured by Celgard, LLC), and the electrolyte solution was injected to produce a laminated cell.

The measurement of the internal resistance increase rate and the measurement of the capacity retention rate were carried out in the same manner as in the case of the evaluation test at the positive electrode, and the results are shown in Table 1-7.

TABLE 1-7

| | | | Examples | | | | | Comparative Examples | | | |
|---|---|---|---|---|---|---|---|---|---|---|---|
| Negative electrode | | | 1-7 | 1-8 | 1-9 | 1-10 | 1-11 | 1-4 | 1-5 | 1-6 | 1-7 |
| Resin current collector | | | S-3 | S-5 | S-6 | S-6 | S-6 | L-1 | S-5 | S-3 | S-2 |
| Electrode active | Part by weight of | AM-1 | 98 | — | — | — | — | 98 | 98 | — | — |
| material layer | coated negative | AM-2 | — | 98 | — | — | — | — | — | — | — |
| | electrode active | AM-3 | — | — | 99 | — | — | — | — | — | — |
| | material particles | AM-4 | — | — | — | 96 | | — | — | — | — |
| | | AM-5 | — | — | — | — | 99 | — | — | — | — |
| | Part by weight of | SBR | — | — | — | 3 | — | — | — | — | — |
| | polymer compound | | | | | | | | | | |
| | Part by weight of | CNF | 2 | 2 | 1 | 1 | 1 | 2 | 2 | 1 | 1 |
| | conductive auxiliary | | | | | | | | | | |
| | agent | | | | | | | | | | |

| | | | | | | | | | |
|---|---|---|---|---|---|---|---|---|---|
| Electrode sliding angle | 180 | 180 | 180 | 180 | 180 | 35 | 38 | 51 | 33 |
| 10-cycle/2-cycle internal | 23.1 | 20.9 | 27.6 | 21.0 | 21.1 | 41.2 | 82.1 | 75.6 | 94.6 |
| resistance increase rate (%) | | | | | | | | | |
| 10-cycle capacity retention rate (%) | 88.7 | 89.4 | 88.9 | 89.1 | 89.3 | 82.6 | 75.4 | 79.5 | 69.8 |

The above evaluation results shows that the negative electrodes of Examples 1-7 to 1-11 have excellent pressure-sensitive adhesiveness between the resin current collector and the electrode active material layer, and also have excellent cycle characteristics.

The electrode for a lithium-ion battery according to the present invention may be the electrode for a lithium-ion battery used as a positive electrode; in the electrode for a lithium-ion battery, the resin current collector may be a resin current collector for a positive electrode in which a conductive filler is dispersed in a matrix resin, the resin current collector for a positive electrode may contain a hindered phenolic antioxidant and/or a hindered amine-based light stabilizer, the conductive filler may contain aluminum and/or titanium, and the total weight proportion of aluminum and titanium may be 99% by weight or more based on the weight of the conductive filler.

Aspects of the electrode for a lithium-ion battery as described above will be described below.

In a lithium ion battery, a metal foil (metal current collector foil) has been conventionally used as a current collector. In recent years, a so-called resin current collector has been proposed, which is composed of a resin to which a conductive material is added instead of the metal foil. Such a resin current collector is lighter than the metal current collector foil, and is expected to improve output per unit weight of the battery.

For example, International Publication No. 2015/005116 discloses a dispersing agent for a resin current collector, a material for a resin current collector containing a resin and a conductive filler, and a resin current collector having the material for a resin current collector.

In recent years, the lithium-ion battery is required to have a higher capacity.

In the lithium ion battery using a conventional resin current collector as a resin current collector on a positive electrode side (resin current collector for a positive electrode) as disclosed in International Publication No. 2015/005116, in a case where the charging voltage is increased for the purpose of increasing the capacity, it is presumed that a side reaction occurs between a matrix resin of the resin current collector and an electrolyte solution or between the conductive filler and the electrolyte solution, and there are problems that the charging voltage cannot be raised to a predetermined voltage (the limit is approximately 4.7 V) and the irreversible capacity increases. Therefore, in the lithium-ion battery using a conventional resin current collector as a resin current collector on the positive electrode side, there is room for further improvement in potential resistance and the size of the irreversible capacity.

As a result of diligent consideration, the inventors have found that, by using a resin current collector containing a hindered phenolic antioxidant and/or a hindered amine-based light stabilizer and containing, as a conductive filler, aluminum and/or titanium in a specific weight proportion, even in a case where the resin current collector is used as a resin current collector on the positive electrode side of the lithium ion battery, it is possible to suppress a side reaction between the matrix resin and an electrolyte solution, which are presumed to occur in a case where a conventional resin current collector is used, or between the conductive filler and the electrolyte solution, and also it is possible to prevent deterioration of members due to side reactions, whereby it is possible to increase the charging voltage and reduce the initial irreversible capacity.

An electrode for a lithium-ion battery described below is an electrode for a lithium-ion battery used as a positive electrode. In the electrode concerned, the resin current collector is a resin current collector for a positive electrode in which a conductive filler is dispersed in a matrix resin, the resin current collector for a positive electrode contains a hindered phenolic antioxidant and/or a hindered amine-based light stabilizer, the conductive filler contains aluminum and/or titanium, and the total weight proportion of aluminum and titanium is 99% by weight or more based on the weight of the conductive filler.

In the electrode for a lithium-ion battery, it is possible to increase a charging voltage for the purpose of increasing the capacity (charging can be performed even in a case where the charging voltage is 5 V), and it is possible to reduce an initial irreversible capacity.

A resin current collector for a positive electrode for use in the electrode for a lithium-ion battery will be described below.

[Resin current collector for a positive electrode] A resin current collector for a positive electrode is a resin current collector for a positive electrode in which a conductive filler is dispersed in a matrix resin, wherein the resin current collector for a positive electrode contains a hindered phenolic antioxidant and/or a hindered amine-based light stabilizer, the conductive filler contains aluminum and/or titanium, and the total weight proportion of aluminum and titanium is 99% by weight or more based on the weight of the conductive filler.

The electrode for a lithium-ion battery described above is a resin current collector for a positive electrode capable of increasing a charging voltage for the purpose of increasing the capacity (charging can be performed even in a case where the charging voltage is 5 V), and also reducing an initial irreversible capacity, even when used as a resin current collector on a positive electrode side.

### Antioxidant and Light Stabilizer

A resin current collector for a positive electrode contains a hindered phenolic antioxidant and/or a hindered amine-based light stabilizer.

Examples of the hindered phenolic antioxidant include, for example, dibutyl hydroxytoluene, tetraki s[3 -(3‘, 5’-di-t-butyl-4′-hydroxyphenyl)propionic acid]pentaerythritol, tris isocyanurate(3, 5-di-tert-butyl-4-hydroxybenzyl), 2,4,6-tris(3′, 5′-di-tert-butyl-4′-hydroxybenzyl)mecitylene, 4-[[4,6-bis(octylthio)-1,3,5-triazine-2-yl]amino]-2, 6-di-tert-butylphenol, bis[3 -(3,5-di-tert-butyl-4-hydroxyphenyl)propionic acid]thiobisethylene, 3-(3,5 -di-tert-butyl-4-hydroxyphenyl)-n′-[3-(3,5 -di-tert-butyl-4-hydroxyphenyl)propanoyl]propanehydrazide, octyl-3,5-di-tert-butyl-4-hydroxy-hydrocarcinate, 2,4-bis(octylthiomethyl)-6-methylphenol, n, n′-hexamethylene bis[3-(3,5-di-tert-butyl-4-hydroxyphenyl)propanamide], bis(3,5-di-tert-butyl hydroxybenzenepropanoic acid)1,6-hexanediyl, bis[3-(3-tert-butyl-4-hydroxy-5-methylphenyl)propionic acid](2,4,8,10-tetraoxaspiro[5.5]undecane-3,9-diyl)bis(2,2-dimethyl-2,1-ethandiyl), bis[3-(3-tert-butyl-4-hydroxy-5-methylphenyl)propionic acid][ethylene bis(oxyethylene)], 1,3,5-tris[[4-(1,1-dimethylethyl)-3 -hydroxy-2,6-dimethylphenyl]methyl]-1,3,5-triazine-2,4,6(1h, 3h, 5h)-trion, 2,2′-methylenebis(6-tert-butyl-p-cresol), 6,6′-thiobis(2-tert-butyl-4-methylphenol), diethyl 3,5-di-tert-butyl-4-hydroxybenzylphosphonate, 2-tert-butyl-4-methyl-6-(2-hydroxy-3-tert-butyl-5-methylbenzyl)phenyl acrylate, 4,4′-thiobis(6-tert-butyl-m-cresol), 6,6′-di-tert-butyl-4,4′-butylidenge-m-cresol, and the like.

Among them, bis [3-(3-tert-butyl-4-hydroxy-5-methylphenyl) propionic acid] [ethylene bis (oxyethylene)] is preferable from the viewpoint of suitably reducing the initial irreversible capacity.

One kind of the hindered phenolic antioxidants may be used alone, or two or more kinds thereof may be used in combination.

Examples of the hindered phenolic antioxidant include, for example, Irganox 245, 259, 565, 1010, 1035, 1081, 1098, 1135, 1330, 1520L, 1790, 3114, MD1024, IRGAMOD 195 (all manufactured by BASF SE), Sumilizer GM, MDP-S, WX-R (all manufactured by Sumitomo Chemical Co., Ltd.), Adekastab AO-40, AO-80 (all manufactured by ADEKA CORPORATION), and the like.

Examples of the hindered amine-based light stabilizer include, for example, bis sevacinate(2,2,6,6-tetramethyl-4-piperidyl), bis(1,2,2,6,6-pentamethyl-4-piperidyl)sebacate, 1,2,3,4-tetrakis(2,2,6,6-tetramethyl-4-piperidyloxycarbonyl)butane, dimethyl succinate-1-(2-hydroxylethyl-4-hydroxy-2,2,6,6-tetramethylpiperidine polycondensate, 1-(3,5-di-t-butyl-4-hydroxyphenyl)-1,1-bis(2,2,6,6-tetramethyl-4-piperidyloxycarbonyl)pentane, n, n-bis(3-aminopropyl)ethylenediamine, 4-benzoyloxy-2,2,6,6-tetramethylpiperidine, bis(octylon-2,2,6,6-tetramethyl-4-piperidyl)sebacate, bis(1,2,2,6,6-pentamethyl-4-piperidyl)[[3,5-bis(1,1-dimethylethyl)-4-hydroxyphenyl]methyl]butyl malonate, and the like.

Among them, dimethyl succinate-1-(2-hydroxylethyl-4-hydroxy-2,2,6,6-tetramethylpiperidine polycondensate is preferable from the viewpoint of suitably reducing the initial irreversible capacity.

One kind of the hindered amine-based light stabilizer may be used alone, or two or more kinds thereof may be used in combination.

Examples of the commercially available hindered amine-based light stabilizer include, for example, Tinuvin 144, 622LD, 622SF (all manufactured by BASF SE), Sanol LS744, LS765, LS770, LS2626 (all manufactured by Sankyo Lifetech Co., Ltd.), Adekastab LA57, LA62, LA63, LA67, LA68 (all manufactured by ADEKA CORPORATION), and the like.

The total weight proportion of aluminum and titanium of the hindered phenolic antioxidant and/or the hindered amine-based light stabilizer is preferably 0.01 to 0.5 by weight based on the weight of the resin current collector for a positive electrode from the viewpoint of suitably suppressing a side reaction between the matrix resin and an electrolyte solution, or between the conductive filler and the electrolyte solution, and suitably reducing the initial irreversible capacity.

The total weight proportion of a hindered phenolic antioxidant and/or a hindered amine-based light stabilizer is more preferably 0.05 to 0.5 by weight, and still more preferably 0.05 to 0.2 by weight

The resin current collector for a positive electrode may contain known antioxidants and light stabilizers.

### Conductive Filler

The conductive filler includes aluminum and/or titanium.

From the viewpoint of suitably reducing the initial irreversible capacity, the conductive filler preferably includes only aluminum.

The aluminum may be pure aluminum or an aluminum alloy. Further, the titanium may be pure titanium or an alloy having titanium as a main material.

A total weight proportion of the aluminum and titanium is 99% by weight or more based on a weight of the conductive filler.

In a case where the total weight proportion of the aluminum and titanium is less than 99% by weight, a conductive filler other than the aluminum or titanium serves as a side reaction source, and the side reaction between the matrix resin and the electrolyte solution or between the conductive filler and the electrolyte solution cannot be sufficiently suppressed. Therefore, the charging voltage cannot be increased for the purpose of increasing the capacity, and the initial irreversible capacity cannot be reduced.

The total weight proportion of the aluminum and titanium is preferably 99.5% by weight or more, more preferably 99.7% by weight or more, and still more preferably 100% by weight based on the weight of the conductive filler.

The above-described total weight proportion means a total weight proportion of the aluminum element and the titanium element based on the weight of the conductive filler.

That is, the above-described “total weight proportion of the aluminum and titanium is 99% by weight or more based on a weight of the conductive filler” means that, in a case where the aluminum and/or titanium is an alloy, the total weight proportion of the aluminum element and the titanium element is 99% by weight or more based on the weight of the conductive filler.

Examples of the conductive filler other than the aluminum or titanium include a metal [nickel, stainless steel (SUS), silver, copper, or the like] other than the aluminum and titanium, carbon [graphite, carbon black (acetylene black, Ketjen black, furnace black, channel black, thermal lamp black, or the like), or the like], and a mixture thereof.

A weight proportion of the conductive filler other than the aluminum or titanium is 1% by weight or less based on the weight of the conductive filler.

A shape (form) of the conductive filler is not particularly limited, and may be a spherical shape, a flake shape, a leaf shape, a dendritic shape, a plate shape, a needle shape, a rod shape, a grape shape, or the like.

An average particle size of the conductive filler is not particularly limited, but from the viewpoint of battery characteristics, is preferably approximately 0.01 to 10 μm.

The “particle size” herein means the maximum distance L among the distances between any two points on the contour line of the conductive filler. As the value of the “average particle size”, the average value of the particle sizes of the particles observed in several to several tens of visual fields using an observation means such as a scanning electron microscope (SEM) or a transmission electron microscope (TEM) shall be calculated and adopted.

From the viewpoint of increasing the charging voltage of the lithium ion battery and viewpoint of suitably reducing the initial irreversible capacity, the weight proportion of the conductive filler is preferably 15% to 60% by weight based on the weight of the resin current collector for a positive electrode.

The weight proportion of the conductive filler is more preferably 15% to 50% by weight and still more preferably 25% to 50% by weight based on the weight of the resin current collector for a positive electrode.

### Matrix Resin

Examples of the matrix resins include a polymer having, as a monomer, ethylene, propylene, styrene chloroethylene, trichlorethylene, vinyl fluoride, vinyl chloride, vinyl acetate, vinylidene chloride, (meth)acrylonitrile, vinylidene fluoride, methyl (meth)acrylate, ethyl (meth)acrylate, propyl (meth)acrylate, butyl (meth)acrylate, hexyl (meth)acrylate, octyl (meth)acrylate, 2-methylhexyl (meth)acrylate, 2-ethylhexyl (meth)acrylate, decyl (meth)acrylate, dodecyl (meth)acrylate, and the like.

One kind of the matric resin may be used alone, or two or more kinds thereof may be used in combination.

The (meth) acrylic acid means acrylic acid and methacrylic acid, and the (meth) acrylonitrile means acrylonitrile and methacrylic nitrile.

A weight average molecular weight of the matrix resin is not particularly limited, but from the viewpoints of moldability and resin strength, is preferably 50,000 to 1,000,000 and more preferably 100,000 to 500,000.

The weight average molecular weight herein means a weight average molecular weight measured by a gel permeation chromatography (GPC) method. Measurement conditions are as follows.

Apparatus: high-temperature gel permeation chromatograph [“Alliance GPC V2000”, manufactured by Waters Corporation] Solvent: orthodichlorobenzene

Reference substance: polystyrene

Sample concentration: 3 mg/ml

Column stationary phase: PLgel 10 μm, two MIXED-B columns connected in series [manufactured by Polymer Laboratories Inc.] Column temperature: 135° C.

A method for obtaining the matrix resin is not particularly limited, and the matrix resin can be obtained by polymerizing the above-described materials by means of known methods.

From the viewpoint of strength, a content of the matrix resin is preferably 40 to 98% by weight, and more preferably 50 to 95% by weight, based on a weight of the resin current collector for a positive electrode.

### Other Components

The resin current collector for a positive electrode may include other components as necessary.

Examples of the other components include a dispersing agent, a colorant, a ultraviolet absorber, and a plasticizer (a phthalic acid skeleton-containing compound, a trimellitic acid skeleton-containing compound, a phosphate group-containing compound, an epoxy skeleton-containing compound, and the like).

As the dispersing agent, UMEX series manufactured by Sanyo Chemical Industries, Ltd., HARDLEN series and TOYO-TAC series manufactured by TOYOBO CO., LTD., or the like can be used.

As the colorant, the ultraviolet absorber, the plasticizer, and the like, known ones can be appropriately selected and used.

A total content of the other components is preferably 0.001% to 5% by weight based on the weight of the resin current collector for a positive electrode.

### Production Method for Resin Current Collector for Positive Electrode

The resin current collector for a positive electrode can be produced, for example, by the following method.

First, the matrix resin, the hindered phenolic antioxidant and/or the hindered amine-based light stabilizer, the conductive filler, and other components as necessary are mixed to obtain a material for a resin current collector.

Examples of the mixing method includes a method of obtaining a masterbatch of the conductive filler and then further mixing the masterbatch with the matrix resin and the hindered phenolic antioxidant and/or the hindered amine-based light stabilizer, a method of using a masterbatch of the matrix resin, the hindered phenolic antioxidant and/or the hindered amine-based light stabilizer, the conductive carbon filler, and other components as necessary, and a method of collectively mixing all raw materials, and for the mixing thereof, it is possible to use a suitable known mixer with which pellet-shaped or powder-shaped components can be mixed, such as a kneader, an internal mixer, a Banbury mixer, or a roll.

The order of addition of each component at the time of mixing is not particularly limited. The obtained mixture may be further pelletized or powdered by a pelletizer or the like.

The obtained material for a resin current collector is formed into, for example, a film shape, whereby the resin current collector for a positive electrode is obtained. Examples of the method of forming a material into a film shape include known film forming methods such as a T-die method, an inflation method, and a calendaring method. The resin current collector for a positive electrode can also be obtained by a forming method other than the film forming.

A thickness of the resin current collector for a positive electrode is not particularly limited, but is preferably 5 to 150 μm.

### Electrode for a Lithium-Ion Battery Including Resin Current Collector for a Positive Electrode

The positive electrode can include a positive electrode active material layer on a surface of the above-described resin current collector for a positive electrode. The positive electrode active material layer includes positive electrode active material particles.

Examples of the positive electrode active material particles include a composite oxide of lithium and a transition metal {a composite oxide having one kind of transition metal (LiCoO₂, LiNiO₂, LiAlMnO₄, LiMnO₂, LiMn₂O₄, or the like), a composite oxide having two kinds of transition metal elements (for example, LiFeMnO₄, LiNi₁₋ₓCoₓO₂, LiMn_{1-y}Co_{y}O₂, LiNi_{1/3}Co_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one examples is LiNi_{1/3}Mn_{1/3}Co_{1/3}O₂)], or the like] the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive polymer (for example, polyaniline, polypyrrole, polythiophene, polyacetylene, poly-p-phenylene, or polyvinyl carbazole), and the like.

One kind of these positive electrode active material particles may be used alone, or two or more kinds thereof may be used in combination.

Here, the lithium-containing transition metal phosphate may be one in which a part of transition metal sites is substituted with another transition metal.

The volume average particle size of the positive electrode active material particles is preferably 0.01 to 100 μm, more preferably 0.1 to 35 μm, and still more preferably 2 to 30 μm, from the viewpoint of the electrical characteristics of the battery.

The positive electrode active material particles may be coated positive electrode active material particles, where at least a part of a surface of the coated positive electrode active material particles is coated with a coating material including a polymer compound.

In a case where a periphery of the positive electrode active material particles is covered by a coating material, the volume change of the positive electrode is alleviated, and thus the expansion of the positive electrode can be suppressed.

As the polymer compound constituting the coating material, those described as an active material coating resin in Japanese Unexamined Patent Application, First Publication No. 2017-054703 and International Publication No. 2015-005117 can be suitably used.

The coating material may include a conductive material.

Examples of the conductive material include, but are not limited thereto, a metal [nickel, aluminum, stainless steel (SUS), silver, copper, titanium, or the like], carbon [graphite, carbon black (acetylene black, Ketjen black, furnace black, channel black, thermal lamp black, or the like), or the like], and a mixture thereof.

One kind of these conductive fillers may be used alone, or two or more kinds thereof may be used in combination.

The positive electrode active material layer may include a pressure-sensitive adhesive resin.

As the pressure-sensitive adhesive resin, it is possible to suitably use, for example, a resin obtained by mixing the non-aqueous secondary battery active material coating resin described in Japanese Unexamined Patent Application, First Publication No. 2017-054703 with a small amount of an organic solvent and adjusting the glass transition temperature thereof to room temperature or lower, and those described as adhesives in Japanese Unexamined Patent Application, First Publication No. H10-255805.

Here, the pressure-sensitive adhesive resin means a resin having pressure-sensitive adhesiveness (an adhering property obtained by applying a slight pressure without using water, solvent, heat, or the like). On the other hand, a solution-drying type binding agent for a lithium-ion battery means a binding agent that dries and distills the solvent to achieve solidification without having pressure-sensitive adhesiveness.

As a result, the above-described binding agent and the pressure-sensitive adhesive resin are different materials.

The positive electrode active material layer may include a conductive auxiliary agent.

As the conductive auxiliary agent, the conductive material used for the above-described coating material can be appropriately selected and used.

A weight proportion of the conductive auxiliary agent in the positive electrode active material layer is preferably 3 to 10% by weight.

The positive electrode active material layer may contain an electrolyte solution.

A known electrolyte solution can be used as the electrolyte solution.

As an electrolyte, an electrolyte used in the known electrolyte solution can be used, and examples thereof include lithium salts of inorganic anion, such as LiPF₆, LiBF₄, LiSbF₆, LiAsF₆, LiClO₄, and LiN(FSO₂)₂, and lithium salts of organic anion, such as LiN(CF₃SO₂)₂, LiN(C₂F₅SO₂)₂, and LiC(CF₃SO₂)₃. Among these, LiN(FSO₂)₂ is preferable from the viewpoints of battery output and charging and discharging cycle characteristics.

As the solvent, a non-aqueous solvent used in the known electrolyte solution can be used, and for example, a lactone compound, a cyclic or chain-like carbonic acid ester, a chain-like carboxylic acid ester, a cyclic or chain-like ether, a phosphoric acid ester, a nitrile compound, an amide compound, a sulfone, a sulfolane, or a mixture thereof can be used.

For example, the positive electrode active material layer can be produced by a method of applying a mixture including the positive electrode active material particles and the electrolyte solution to the surface of the resin current collector for a positive electrode or a base material to remove excess electrolyte solution, a method of molding a mixture including the positive electrode active material particles and the electrolyte solution by applying pressure or the like on a base material, or the like.

In a case where the positive electrode active material layer is formed on the surface of the base material, the positive electrode active material layer may be combined with the resin current collector for a positive electrode by a method such as transferring.

The above-described mixture may include a conductive auxiliary agent or a pressure-sensitive adhesive resin, as necessary. Further, the positive electrode active material particles may be the coated positive electrode active material particles.

A thickness of the positive electrode active material layer is not particularly limited, but from the viewpoint of battery performance, is preferably 150 to 600 μm and more preferably 200 to 450 μm.

[Lithium-ion battery] The lithium-ion battery may include the above-described resin current collector for a positive electrode.

The lithium-ion battery may include an electrode including the above-described resin current collector for a positive electrode, a separator, and a negative electrode.

An example of a separator and a negative electrode that can be used in combination with a positive electrode including the above-described resin current collector for a positive electrode will be described below.

### Separator

Examples of the separator include known separators for a lithium-ion battery, such as a porous film made of polyethylene or polypropylene, a lamination film of a porous polyethylene film and a porous polypropylene, a non-woven fabric made of a synthetic fiber (a polyester fiber, an aramid fiber, or the like), a glass fiber, or the like and those above of which the surface is attached with ceramic fine particles such as silica, alumina, and titania.

### Negative Electrode

The negative electrode includes a negative electrode current collector and a negative electrode active material layer.

As the negative electrode current collector, a resin current collector (resin current collectors described in Japanese Unexamined Patent Application, First Publication No. 2012-150905 and International Publication No. 2015-005116, and the like) composed of a known metal current collector and a conductive resin composition including a conductive material and a resin can be used.

From the viewpoint of battery characteristics and the like, the negative electrode current collector is preferably a resin current collector.

A thickness of the negative electrode current collector is not particularly limited, but is preferably 5 to 150 μm.

The negative electrode active material layer includes negative electrode active material particles.

Examples of the negative electrode active material particles include a carbon-based material [graphite, non-graphitizable carbon, amorphous carbon, a resin sintered product (for example, a sintered product obtained by sintering and carbonizing a phenol resin, a furan resin, or the like), cokes (for example, a pitch coke, a needle coke, and a petroleum coke), carbon fiber, or the like], a silicon-based material [silicon, silicon oxide (SiOx), a silicon-carbon composite body (a composite body obtained by coating surfaces of carbon particles with silicon and/or silicon carbide, a composite body obtained by coating surfaces of silicon particles or silicon oxide particles with carbon and/or silicon carbide, silicon carbide, or the like), a silicon alloy (a silicon-aluminum alloy, a silicon-lithium alloy, a silicon-nickel alloy, a silicon-iron alloy, a silicon-titanium alloy, a silicon-manganese alloy, a silicon-copper alloy, a silicon-tin alloy, or the like), or the like], a conductive polymer (for example, polyacetylene or polypyrrole), a metal (tin, aluminum, zirconium, titanium, or the like), a metal oxide (a titanium oxide, a lithium-titanium oxide, or the like), a metal alloy (for example, a lithium-tin alloy, a lithium-aluminum alloy, or a lithium-aluminum-manganese alloy), or the like, and a mixture of the above and a carbon-based material.

One kind of the negative electrode active material particles may be used alone, or two or more kinds thereof may be used in combination.

The volume average particle size of the negative electrode active material particles is preferably 0.01 to 100 μm, more preferably 0.1 to 20 μm, and still more preferably 2 to 10 μm, from the viewpoint of the electrical characteristics of the battery.

The negative electrode active material particles may be coated negative electrode active material particles, where at least a part of a surface of the coated negative electrode active material particles is coated with a coating material including a polymer compound.

In a case where a periphery of the negative electrode active material particles is covered by a coating material, the volume change of the negative electrode is alleviated, and thus the expansion of the negative electrode can be suppressed.

As the coating material, the same one as the coating material described in the above positive electrode active material particles can be suitably used.

The negative electrode active material layer may include a pressure-sensitive adhesive resin.

As the pressure-sensitive adhesive resin, the same one as the pressure-sensitive adhesive resin which is an optional component of the positive electrode active material layer can be suitably used.

The negative electrode active material layer may include a conductive auxiliary agent.

As the conductive auxiliary agent, the same conductive material as the conductive filler included in the positive electrode active material layer can be suitably used.

A weight proportion of the conductive auxiliary agent in the negative electrode active material layer is preferably 2% to 10% by weight.

The negative electrode active material layer may include an electrolyte solution.

As the electrolyte solution, those described in the positive electrode active material layer can be appropriately selected and used.

For example, the negative electrode active material layer can be produced by a method of applying a mixture including the negative electrode active material particles and the electrolyte solution to the surface of the negative electrode current collector or the base material and then removing excess electrolyte solution.

In a case where the negative electrode active material layer is formed on the surface of the base material, the negative electrode active material layer may be combined with the negative electrode current collector by a method such as transferring.

The above-described mixture may include a conductive auxiliary agent, a pressure-sensitive adhesive resin, or the like, as necessary. Further, the negative electrode active material particles may be the coated negative electrode active material particles.

A thickness of the negative electrode active material layer is not particularly limited, but from the viewpoint of battery performance, is preferably 150 to 600 μm and more preferably 200 to 450 μm.

### Production Method for Lithium-Ion Battery

The above-described lithium-ion battery can be produced, for example, by stacking the positive electrode, the separator, and the negative electrode in this order, and then injecting the electrolyte solution as needed.

### EXAMPLES

### Example 2-1

50 parts of polypropylene [PP, product name “SunAllomer PC684S”, manufactured by SunAllomer Ltd.] as a matrix resin, 50 parts of aluminum [product name “Aluminum (powder)”, manufactured by NACALAI TESQUE, INC.] as a conductive filler and a hindered phenolic antioxidant [product name “Irganox 245”, manufactured by BASF SE) were melted and kneaded with a twin-screw extruder under the conditions of 180° C., 100 rpm to obtain a material of a resin current collector for a positive electrode. The obtained material of a resin current collector for a positive electrode was rolled by a hot press machine to produce a resin current collector for a positive electrode.

### Example 2-2

A resin current collector for a positive electrode was produced in the same manner as in Example 2-1, except that a hindered phenolic antioxidant is changed to 0.1 parts of a hindered amine-based light stabilizer [product name “Tinuvin 622SF” (manufactured by BASF SE)].

### Example 2-3

A resin current collector for a positive electrode was produced in the same manner as in Example 2-2, except that 50 parts of titanium [product name “Titanium/powder”, manufactured by The Nilaco Corporation] was used as the conductive filler.

### Example 2-4

A resin current collector for a positive electrode was produced in the same manner as in Example 2-2, except that 25 parts of aluminum [product name “Aluminum (powder)”, manufactured by NACALAI TESQUE, INC.] and 25 parts of titanium [product name “Titanium/powder”, manufactured by The Nilaco Corporation] were used as the conductive filler.

### Example 2-5

A resin current collector for a positive electrode was produced in the same manner as in Example 2-2, except that 49.5 parts of aluminum [product name “Aluminum (powder)”, manufactured by NACALAI TESQUE, INC.] and 0.5 parts of carbon black [ENSACO, product name “E-250G”, manufactured by Imerys G&C Japan] were used as the conductive filler.

### Example 2-6

A resin current collector for a positive electrode was produced in the same manner as in Example 2-1, except that 0.05 parts of a hindered phenolic antioxidant [product name “Irganox 245”, manufactured by BASF SE) and 0.05 parts of a hindered amine-based light stabilizer [product name “Tinuvin 622SF” (manufactured by BASF SE)] were used in combination.

### Example 2-7

A resin current collector for a positive electrode was produced in the same manner as in Example 2-2, except that 0.01 parts of a hindered amine-based light stabilizer [product name “Tinuvin 622SF” (manufactured by BASF SE)] was used instead.

### Example 2-8

A resin current collector for a positive electrode was produced in the same manner as in Example 2-2, except that 0.5 parts of a hindered amine-based light stabilizer [product name “Tinuvin 622SF” (manufactured by BASF SE)] was used instead.

### Example 2-9

A resin current collector for a positive electrode was produced in the same manner as in Example 2-2, except that 1.0 parts of a hindered amine-based light stabilizer [product name “Tinuvin 622SF” (manufactured by BASF SE)] was used instead.

### Comparative Example 2-1

A resin current collector for a positive electrode was produced in the same manner as in Example 2-2, except that no hindered amine-based light stabilizer [product name “Tinuvin 622SF” (manufactured by BASF SE)] was used.

### Comparative Example 2-2

A resin current collector for a positive electrode was produced in the same manner as in Example 2-1, except that 50 parts of carbon black [ENSACO, product name “E-250G”, manufactured by Imerys G&C Japan] were used as the conductive filler and no hindered phenolic antioxidant was used.

### Comparative Example 2-3

A resin current collector for a positive electrode was produced in the same manner as in Example 2-2, except that 48 parts of aluminum [product name “Aluminum (powder)”, manufactured by NACALAI TESQUE, INC.] and 2 parts of carbon black [ENSACO, product name “E-250G”, manufactured by Imerys G&C Japan] were used as the conductive filler.

### Production of Evaluation Battery

Half cells using the resin current collectors for a positive electrode produced in Examples 2-1 to 2-9 and Comparative Examples 2-1 to 2-3 were produced by the following method, respectively.

From a positive electrode side, a carbon-coated aluminum foil [product name “Carbon-coated aluminum foil”, manufactured by TOYO ALUMINIUM K.K.], a resin current collector for a positive electrode (thickness: 0.5 mm, 6.25 cm2), a separator [product name “#3501”, manufactured by Celgard, LLC], a lithium metal foil (6.25 cm2) [product name “Lithium foil (thickness 0.5 mm)”, manufactured by Honjo Metal Co., Ltd.], and a copper foil (6.25 cm2) [product name “Electrolytic copper foil (thickness 0.2 mm)”, manufactured by FURUKAWA ELECTRIC CO., LTD.] were stacked in this order, and an electrolyte solution was injected thereto to produce a half cell.

As the electrolyte solution, an electrolyte solution including 1 M of LiN(FSO2)2 as an electrolyte and including, as a solvent, ethylene carbonate and propylene carbonate in a weight proportion of 1:1 was used.

### Measurement of Initial Irreversible Capacity in 5 V Charging

Using the produced half cell, constant current charging and discharging was performed at 10 μA with an upper limit voltage of 5.0 V.

It was confirmed whether each of the half cells could be charged to 5.0 V. Further, in a case where the half cell could be charged to 5.0 V, an initial irreversible capacity (mAh/g) was measured from a difference between the initial charge capacity and the initial discharge capacity. The results are shown in Table 2-1.

TABLE 2-1

| | | | | | | | | Initial |
|---|---|---|---|---|---|---|---|---|
| | | Matrix resin | | Conductive filler | | Antioxidant/light stabilizer | | irreversible |
| | | | Blending | | Blending | | Blending | capacity |
| | | | amount | | amount | | amount | (mAh/g) |
| | | | (part by | | (part by | | (part by | at 5 V |
| | | Type | weight) | Type | weight) | Type | weight) | charging |
| Examples | 2-1 | PP | 50 | Aluminum | 50 | Irganox 245 | 0.1 | 64 |
| | 2-2 | PP | 50 | Aluminum | 50 | Tinuvin 622SF | 0.1 | 31 |
| | 2-3 | PP | 50 | Titanium | 50 | Tinuvin 622SF | 0.1 | 40 |
| | 2-4 | PP | 50 | Aluminum/ | 25/25 | Tinuvin 622SF | 0.1 | 37 |
| | | | | titanium | | | | |
| | 2-5 | PP | 50 | Aluminum/ | 49.5/0.5 | Tinuvin 622SF | 0.1 | 55 |
| | | | | carbon black | | | | |
| | 2-6 | PP | 50 | Aluminum | 50 | Irganox 245/ | 0.05/0.05 | 49 |
| | | | | | | Tinuvin 622SF | | |
| | 2-7 | PP | 50 | Aluminum | 50 | Tinuvin 622SF | 0.01 | 69 |
| | 2-8 | PP | 50 | Aluminum | 50 | Tinuvin 622SF | 0.5 | 30 |
| | 2-9 | PP | 50 | Aluminum | 50 | Tinuvin 622SF | 1.0 | 40 |
| Comparative | 2-1 | PP | 50 | Aluminum | 50 | None | | 84 |
| Example | 2-2 | PP | 50 | Carbon black | 50 | None | | 5 V charging |
| | | | | | | | | not possible |
| | 2-3 | PP | 50 | Aluminum/ | 48/2 | Tinuvin 622SF | 0.1 | 101 |
| | | | | carbon black | | | | |

From Examples 2-1 to 2-9, it was confirmed that, by using a resin current collector for a positive electrode, in which a matrix resin includes a hindered phenolic antioxidant and/or a hindered amine-based light stabilizer and includes, as a conductive filler, aluminum and/or titanium in a specific weight proportion, the charging voltage could be increased and the initial irreversible capacity could be reduced.

The present specification describes the following technical ideas described in the basic application of this international application.

(1-1) An electrode for a lithium-ion battery, comprising:

a resin current collector; and

an electrode active material layer formed on the resin current collector, and containing coated electrode active material particles in which at least a part of a surface of an electrode active material particle is coated with a coating layer including a polymer compound,

wherein the resin current collector has a recess on a principal surface that comes into contact with the electrode active material layer,

the relationship between the maximum depth (D) of the recess and the D50 particle size (R) of the electrode active material particles satisfies 1.0 R≤D≤6.5 R, and

the relationship between the length (S) of the shortest part of the length passing through the center of gravity of the recess and the D50 particle size (R) of the electrode active material particles satisfies 1.5 R≤S.

(1-2) The electrode for a lithium-ion battery according to (1-1), wherein the recess has two or more recesses having different shapes of figures as seen from above.
(1-3) The electrode for a lithium-ion battery according to (1-1) or (1-2), wherein the recess has a recess having an aspect ratio of 2.0 to 4.0 and a recess having an aspect ratio of 0.25 to 0.5.
(1-4) The electrode for a lithium-ion battery according to any of (1-1) to (1-3), wherein the recess has an elliptical shape as seen from above.
(1-5) The electrode for a lithium-ion battery according to any of (1-1) to (1-4), wherein the D50 particle size (R) of the electrode active material particles is 5 to 25 μm.
(2-1) A resin current collector for a positive electrode which is a resin current collector for a positive electrode in which a conductive filler is dispersed in a matrix resin,

the resin current collector for a positive electrode contains a hindered phenolic antioxidant and/or a hindered amine-based light stabilizer, and

the conductive filler contains aluminum and/or titanium, and the total weight proportion of aluminum and titanium is 99% by weight or more based on the weight of the conductive filler.

(2-2) The electrode for a lithium-ion battery according to (2-1), wherein the total weight proportion of the hindered phenolic antioxidant and/or the hindered amine-based light stabilizer contained in the resin current collector for a positive electrode is 0.01 to 0.5% by weight based on the weight of the resin current collector for a positive electrode.
(2-3) The electrode for a lithium-ion battery according to (2-1) or (2-2), wherein the total weight proportion of conductive filler contained in the resin current collector for a positive electrode is 15 to 60% by weight based on the weight of the resin current collector for a positive electrode.
(2-4) A lithium-ion battery comprising the electrode for a lithium-ion battery according to any one of (2-1) to (2-3).

Incidentally, the resin current collector for a positive electrode that is described in (2-1) to (2-3) above and does not satisfy the requirements as a resin current collector used in the lithium-ion electrode described in (1-1) above is also disclosed herein.

Further, the lithium-ion battery that is described in (2-4) above and does not use the electrode for a lithium-ion battery described in (1-1) above is also disclosed herein.

### INDUSTRIAL APPLICABILITY

The electrode for a lithium-ion battery of the present invention makes it possible to reduce contact resistance between the resin current collector and the electrode active material layer and have excellent adhesiveness between the resin current collector and the electrode active material layer. Therefore, the lithium-ion battery including the electrode is suitable for use as a battery for electric vehicles, hybrid electric vehicles, and the like, and portable electronic devices.

### REFERENCE SIGNS LIST

1 electrode for a lithium-ion battery

10 resin current collector

10′ resin current collector before forming recesses

11 principal surface in contact with an electrode active material layer

12, 12a, 12b recess

20 electrode active material layer

21 electrode active material particles

22 coating layer

23 coated electrode active material particles

24 conductive auxiliary agent

30 conductive filler

40 mesh

1. An electrode for a lithium-ion battery, comprising:
a resin current collector; and
an electrode active material layer formed on the resin current collector, and containing coated electrode active material particles in which at least a part of a surface of an electrode active material particle is coated with a coating layer including a polymer compound,
wherein the resin current collector has a recess on a principal surface that comes into contact with the electrode active material layer,
the relationship between the maximum depth (D) of the recess and the D50 particle size (R) of the electrode active material particles satisfies 1.0 R≤D≤6.5 R, and
the relationship between the length (S) of the shortest part of the length passing through the center of gravity of the recess and the D50 particle size (R) of the electrode active material particles satisfies 1.5 R≤S.

2. The electrode for a lithium-ion battery according to claim 1, wherein the recess has two or more recesses having different shapes of figures as seen from above.

3. The electrode for a lithium-ion battery according to claim 1, wherein the recess has a recess having an aspect ratio of 2.0 to 4.0 and a recess having an aspect ratio of 0.25 to 0.5.

4. The electrode for a lithium-ion battery according to claim 1, wherein the recess has an elliptical shape as seen from above.

5. The electrode for a lithium-ion battery according claim 1, wherein the D50 particle size (R) of the electrode active material particles is 5 to 25 μm.

6. The electrode for a lithium-ion battery according to claim 1, used for a negative electrode.

7. The electrode for a lithium-ion battery according to claim 1, used as a positive electrode,
wherein the resin current collector is a resin current collector for a positive electrode in which a conductive filler is dispersed in a matrix resin,
the resin current collector for a positive electrode contains a hindered phenolic antioxidant and/or a hindered amine-based light stabilizer, and
the conductive filler contains aluminum and/or titanium, and the total weight proportion of aluminum and titanium is 99% by weight or more based on the weight of the conductive filler.

8. The electrode for a lithium-ion battery according to claim 7, wherein the total weight proportion of the hindered phenolic antioxidant and/or the hindered amine-based light stabilizer contained in the resin current collector for a positive electrode is 0.01 to 0.5% by weight based on the weight of the resin current collector for a positive electrode.

9. The electrode for a lithium-ion battery according to claim 7, wherein the total weight proportion of conductive filler contained in the resin current collector for a positive electrode is 15 to 60% by weight based on the weight of the resin current collector for a positive electrode.

10. A lithium-ion battery comprising the electrode for a lithium-ion battery according to claim 1.
